(19) United States
(12) Patent Application Publication
(10) Pub. No.: US 2022/0028003 A1
(43) Pub. Date: Jan. 27, 2022

(54) Strategic Advice Manager for Financial Plans

(71) Applicant: Conquest Planning Inc., Winnipeg (CA)

(72) Inventors: Mark Evans, Winnipeg (CA); James Teitsma, Winnipeg (CA); Paul Thiessen, Winnipeg (CA); Ken Lotocki, Winnipeg (CA)

(21) Appl. No.: 17/414,184

(22) PCT Filed: Feb. 28, 2020
(86) PCT No.: PCT/CA2020/050275

§ 371 Date: Jun. 15, 2021

Related U.S. Application Data
(60) Provisional application No. 62/812,362, filed on Mar. 1, 2019.

(51) Int. Cl. G06Q 40/06; G06N 5/02; G06N 5/04

(52) U.S. Cl. CPC G06Q 40/06; G06N 5/045; G06N 5/022

(57) ABSTRACT

Described herein is a financial planning system that comprises a Strategic Advice Manager (SAM) module that utilizes an artificial intelligence (AI) module to automate and optimize the financial planning decision-making process, reducing the margin of error created by depending solely on a human-advisor and reducing the time required to build a financial plan, as discussed herein. That is, the financial planning system incorporates artificial intelligence techniques to analyze client inputs and select appropriate financial strategies based on the analysis of the inputs.

### PRIOR APPLICATION INFORMATION

The instant application claims the benefit of U.S. Provisional Patent Application 62/812,362, filed Mar. 1, 2019 and entitled “STRATEGIC ADVICE MANAGER FOR FINANCIAL PLANS”, the entire contents of which are incorporated herein by reference for all purposes.

### BACKGROUND OF THE INVENTION

A financial plan is a comprehensive evaluation of an investor's current and future financial state by using currently known variables to predict future cash flows, asset values and withdrawal plans. Most individuals work in conjunction with a financial planner and use current income, net worth, tax liabilities, asset allocation, and future retirement and estate plans in developing financial plans. These metrics are used along with estimates of asset growth to determine if a person's financial goals can be met in the future, or what steps need to be taken to ensure that they are met.

Personal financial goals are objectives such as retirement, education (for dependents or themselves), and/or a major expense (i.e. new car, wedding, etc.). A comprehensive financial plan will include a holistic analysis of all goals and will span the lifetime of an individual and their household.

Depending on the age and wealth of the client, the retirement goal can centre on accumulation (the period of time when an individual is saving and growing their investments) or decumulation (the period of time when an individual is dependent on various sources of income, such as investments, for their retirement spending needs.)

Many individuals begin planning for retirement well in advance. Such planning frequently includes planning for the financial impact of the elimination of employment income and the addition of income from other sources, such as pensions or Social Security benefits. This financial planning also typically includes saving and investment decisions, as well as estimates of income required or desired during retirement. The decision of when a person should retire is also a key factor in retirement planning. This decision is generally a function of at least four major factors: (1) the amount of income a person needs or desires to draw in his retirement; (2) when that person will retire; (3) how much that person is able to save for retirement; and (4) how retirement funds are invested.

Financial planners frequently utilize software tools to formulate retirement plans for their clients. As with other aspects of the typical retirement planning process, these tools focus on the fourth major retirement planning factor, namely, the mix of assets in a prospective retiree's account. Few, if any, of the existing software tools facilitate changes to the other major factors that may affect a retiree's income. Instead, these prior art planning tools will include static entry fields for the retiree's desired income, projected retirement age, and current savings, which will then be used to devise a sampling of plans based upon those static factors.

When financial planners attempt to develop more complex financial plans, the time and effort required to produce new projections of different scenarios increases. For example, considering risk protection mechanisms and factoring in regular withdrawals may require producing multiple sets of projects for each scenario adjustment. Few existing software tools allow a financial planner the flexibility to vary multiple primary and secondary parameters in response to a client inquiry, and even those tools lack the capability to generate real-time projections or projection summaries to present to a client in response to changes in the parameters. The ability to generate and display “what if” scenarios in real-time for a sliding scale of changes and assumptions (e.g., postponing retirement by various lengths of time, increasing savings by various amounts prior to retirement, or adjusting life expectancy) is not available in existing retirement planning tools.

In other cases, a user may rely on industry standard recommendations or will make “rule of thumb” recommendations that may not be in the best interests of the client and/or may not consider the client's specific circumstances and/or sentiments.

Because of the complexities of the financial planning process and the significant room for error presented by existing software tools, there exists a need to automate the evaluation of various recommendations and provide guidance to an advisor (or end-client) as to the best financial decision(s) for the holistic financial plan.

### SUMMARY OF THE INVENTION

According to an aspect of the invention, there is provided a non-transitory computer-readable medium bearing code which, when executed by at least one processor of a computer system, causes the computer system to implement the method comprising:

issuing, over a network, a stream of questions to a user computing device;

receiving, over the network, a stream of inputs for a financial plan module in response to the stream of questions, at least a first subset of the stream of inputs defining one or more financial goals, a second subset of the stream of inputs defining client lifestyle preferences and a third subset of the stream of inputs defining client financial information;

executing the financial plan module to generate a first financial plan comprising said one or more financial goals using the stream of inputs;

displaying the first financial plan to the user;

running an artificial intelligence engine, said artificial intelligence engine:
analyzing the stream of inputs and determining client lifestyle parameters from the client lifestyle preferences;
accessing each respective one of a series of financial strategies and executing the financial plan module to generate a respective one of a set of modified financial plans, each respective one of the set of modified financial plans representing the financial goal as modified by the respective one of the series of financial strategies;
assigning a score to each respective one of the set of modified financial plans based on an increase in said respective one of the set of modified financial plans relative to the first financial plan and a cost of the corresponding respective one of the series of financial strategies based on client lifestyle parameters; and
ranking each respective one of the set of modified financial plans relative to each other based on said respective score; and
selecting a highest ranked modified financial plan of the set of modified financial plans; and

modifying the display to show the highest ranked modified financial plan.

According to another aspect of the invention, there is provided a method of preparing a financial plan for achieving one or more financial goals comprising:

issuing, over a network, a stream of questions to a user computing device;

receiving, over the network, a stream of inputs for a financial plan module in response to the stream of questions, at least a first subset of the stream of inputs defining one or more financial goals, a second subset of the stream of inputs defining client lifestyle preferences and a third subset of the stream of inputs defining client financial information;
a) executing the financial plan module to generate a first financial plan comprising said one or more financial goals using the stream of inputs;
b) displaying the first financial plan to the user;
c) running an artificial intelligence engine, said artificial intelligence engine:
d) analyzing the stream of inputs and determining client lifestyle parameters from the client lifestyle preferences;
e) accessing each respective one of a series of financial strategies and executing the financial plan module to generate a respective one of a set of modified financial plans, each respective one of the set of modified financial plans representing the financial goal as modified by the respective one of the series of financial strategies;
f) assigning a score to each respective one of the set of modified financial plans based on an increase in said respective one of the set of modified financial plans relative to the first financial plan and a cost of the corresponding respective one of the series of financial strategies based on client lifestyle parameters; and
g) ranking each respective one of the set of modified financial plans relative to each other based on said respective score; and
h) selecting a highest ranked modified financial plan of the set of modified financial plans; and
i) modifying the display to show the highest ranked modified financial plan.

According to a further aspect of the invention, there is provided a non-transitory computer-readable medium bearing code which, when executed by at least one processor of a computer system, causes the computer system to implement the method comprising:

a) issuing, over a network, a stream of questions to a user computing device;

b) receiving, over the network, a stream of inputs for a financial plan module in response to the stream of questions, at least a first subset of the stream of inputs defining one or more financial goals, a second subset of the stream of inputs defining client lifestyle preferences and a third subset of the stream of inputs defining client financial information;

c) executing the financial plan module to generate a first financial plan comprising the one or more financial goals using the stream of inputs;

d) displaying the first financial plan to the user;

e) running an artificial intelligence engine, said artificial intelligence engine:

f) analyzing the stream of inputs and determining client lifestyle parameters from the client lifestyle preferences;

g) accessing each respective one of a series of financial strategies and executing the financial plan module to generate a respective one of a set of modified financial plans, each respective one of the set of modified financial plans representing the first financial goal as modified by the respective one of the series of financial strategies;

h) assigning a score to each respective one of the set of modified financial plans based on an increase in said respective one of the set of modified financial plans relative to the first financial plan and a cost of the corresponding respective one of the series of financial strategies based on client lifestyle parameters; and

i) ranking each respective one of the set of modified financial plans relative to each other based on said respective score; and

j) selecting a highest ranked modified financial plan of the set of modified financial plans; and

k) modifying the display to show the highest ranked modified financial plan,

l) at the user computer device, said user accepting or rejecting the highest ranked financial plan, wherein:

if the user rejects the highest ranked financial plan, modifying the display to show the next highest ranked financial plan;

if the user accepts the highest ranked financial plan, asking the user if the financial goal has been met, wherein:

if the first financial goal has not been met, setting the accepted highest ranked financial plan as the first financial plan and repeating steps (e) to (l) until the financial goal has been met.

According to yet another aspect of the invention, there is provided a method for developing a financial plan for achieving one or more financial goals, said method comprising:

a) issuing, over a network, a stream of questions to a user computing device;

b) receiving, over the network, a stream of inputs for a financial plan module in response to the stream of questions, at least a first subset of the stream of inputs defining one or more financial goals, a second subset of the stream of inputs defining client lifestyle preferences and a third subset of the stream of inputs defining client financial information;

c) executing the financial plan module to generate a first financial plan comprising the one or more financial goals using the stream of inputs;

d) displaying the first financial plan to the user;

e) running an artificial intelligence engine, said artificial intelligence engine:

f) analyzing the stream of inputs and determining client lifestyle parameters from the client lifestyle preferences;

g) accessing each respective one of a series of financial strategies and executing the financial plan module to generate a respective one of a set of modified financial plans, each respective one of the set of modified financial plans representing the first financial goal as modified by the respective one of the series of financial strategies;

h) assigning a score to each respective one of the set of modified financial plans based on an increase in said respective one of the set of modified financial plans relative to the first financial plan and a cost of the corresponding respective one of the series of financial strategies based on client lifestyle parameters; and

i) ranking each respective one of the set of modified financial plans relative to each other based on said respective score; and

j) selecting a highest ranked modified financial plan of the set of modified financial plans; and

k) modifying the display to show the highest ranked modified financial plan,

l) at the user computer device, said user accepting or rejecting the highest ranked financial plan, wherein:

if the user rejects the highest ranked financial plan, modifying the display to show the next highest ranked financial plan;

if the user accepts the highest ranked financial plan, asking the user if the financial goal has been met, wherein:

if the first financial goal has not been met, setting the accepted highest ranked financial plan as the first financial plan and repeating steps (e) to (1) until the financial goal has been met.

According to another aspect of the invention, there is provided a method for training an artificial intelligence to develop a financial plan for achieving one or more financial goals, said method comprising:

a) issuing, over a network, a stream of questions to a user computing device;

b) receiving, over the network, a stream of inputs for a financial plan module in response to the stream of questions, at least a first subset of the stream of inputs defining one or more financial goals, a second subset of the stream of inputs defining client lifestyle preferences and a third subset of the stream of inputs defining client financial information;

c) executing the financial plan module to generate a first financial plan comprising the one or more financial goals using the stream of inputs;

d) displaying the first financial plan to the user;

e) running an artificial intelligence engine, said artificial intelligence engine:

f) analyzing the stream of inputs and determining client lifestyle parameters from the client lifestyle preferences;

g) accessing each respective one of a series of financial strategies and executing the financial plan module to generate a respective one of a set of modified financial plans, each respective one of the set of modified financial plans representing the first financial goal as modified by the respective one of the series of financial strategies;

h) assigning a score to each respective one of the set of modified financial plans based on an increase in said respective one of the set of modified financial plans relative to the first financial plan and a cost of the corresponding respective one of the series of financial strategies based on client lifestyle parameters; and

i) ranking each respective one of the set of modified financial plans relative to each other based on said respective score; and

j) selecting a highest ranked modified financial plan of the set of modified financial plans; and

k) modifying the display to show the highest ranked modified financial plan,

l) at the user computer device, said user accepting or rejecting the highest ranked financial plan, wherein:

if the user rejects the highest ranked financial plan, modifying the display to show the next highest ranked financial plan;

if the user accepts the highest ranked financial plan, asking the user if the financial goal has been met, wherein:

if the first financial goal has not been met, setting the accepted highest ranked financial plan as the first financial plan and repeating steps (e) to (l) until the financial goal has been met,

characterized in that said artificial intelligence engine is configured to learn knowledge about general financial plan preferences from past ones of client financial plans and apply the learned knowledge to future ones of client financial plans.

### BRIEF DESCRIPTION OF THE DRAWINGS

FIG. 1 is one embodiment of a first client data entry screen for selecting aspects of a financial plan.

FIG. 2 is one embodiment of a client data entry screen for uploading financial information.

FIG. 3 is one embodiment of a client data entry screen for providing property ownership information.

FIG. 4 is one embodiment of a client data entry screen for providing information on client sentiment regarding retirement spending levels.

FIG. 5 is one embodiment of a client data entry screen for providing information on client planning preferences and sentiments.

FIG. 6 is one embodiment of the dynamic financial plan display.

FIG. 7 is an updated display from FIG. 6 wherein a first financial strategy has been applied to produce an updated financial plan.

FIG. 8 is an updated display from FIG. 7 wherein a second financial strategy has been applied to produce a further updated financial plan.

FIG. 9 is an updated display from FIG. 8 wherein a third financial strategy has been applied to produce a further updated financial plan.

FIG. 10 is an updated display from FIG. 9 wherein a second financial goal has been selected and a new financial strategy has been applied to the financial plan to achieve the second financial goal.

FIG. 11 is an updated display from FIG. 10 wherein a third financial goal has been selected and a new financial strategy has been applied to the financial plan to achieve the third financial goal.

FIG. 12 is an updated display from FIG. 11 wherein another financial strategy has been applied to the financial plan to achieve the third financial goal.

FIG. 13 is an updated display from FIG. 12 wherein another financial strategy has been applied to the financial plan and the system now projects that the third financial goal can be met by the current plan.

FIG. 14 is one embodiment of a status screen for a financial advisor showing more details on the ranking of the financial strategy ranking during generation of the financial plan.

FIG. 15 is one embodiment of a status screen for a financial advisor showing more specific details on the financial plan.

### DESCRIPTION OF THE PREFERRED EMBODIMENTS

Unless defined otherwise, all technical and scientific terms used herein have the same meaning as commonly understood by one of ordinary skill in the art to which the invention belongs. Although any methods and materials similar or equivalent to those described herein can be used in the practice or testing of the present invention, the preferred methods and materials are now described. All publications mentioned hereunder are incorporated herein by reference.

Described herein is a financial planning system that comprises a Strategic Advice Manager (SAM) module that utilizes an artificial intelligence (AI) module to automate and optimize the financial planning decision-making process, reducing the margin of error created by depending solely on a human-advisor and reducing the time required to build a financial plan, as discussed herein. That is, the financial planning system incorporates artificial intelligence techniques to analyze client inputs and select appropriate financial strategies based on the analysis of the inputs. In some embodiments, the AI learns from client inputs to better predict the sentiments and/or choices of future clients/users, as discussed below.

Specifically, the invention relies on modelling and evaluating a set of individual financial planning strategies. The strategies, which are constantly ranked and prioritized against the financial plan, generally fall into one or more categories such as: savings/contributions to investment accounts; delay of current strategies (retirement age, government pensions, etc.); optimized withdrawal plans; and optimized investment strategies, as discussed herein. Furthermore, the AI module is arranged to apply other strategies that have an impact on client lifestyle, both current and projected, such as for example opportunities for earlier retirement, or increased spending, as discussed below. Specifically, the AI module is arranged to use the client sentiment data to estimate importance of specific lifestyle considerations to respective clients, as discussed herein.

The financial plan incorporates a plurality of projections regarding future values related to the client's income, expenses, assets, and liabilities during their lifetime. The projections may begin with current values of assets (e.g., pre-tax investment accounts such as 401Ks, Registered Retirement Savings Plans (RRSPs) or Self-Invested Personal Pensions (SIPPs)) or estimates of future income sources (e.g., government benefits and/or pensions such as Canadian Pension Plan (CPP), Social Security or State Pension). The projections may then apply a number of assumptions regarding rates of return, inflation, taxes, years until retirement, or other similar parameters to determine projected values for the client's assets and income throughout the lifetime of a client. The rate of return, retirement age, and withdrawals from assets are of particular importance in determining whether the retirement plan will meet the client's retirement income goals.

In some embodiments, the financial plan may include projections based upon parameters associated with one or more of the following: retirement income from one or more sources during retirement, expenses during retirement, retirement age, rate of return on investments, rate of return on other assets, length of client life, healthcare expenses, recurring expenses, nonrecurring expenses, education expenses and major expenses (such as a home, or vacation), as discussed below.

In some embodiments, the financial plan may include an income stability ratio as a measure of volatility in the projections based upon market risk.

For example, in one embodiment of the invention, the financial planning system may be organized according to a modular relationship in which various modules model, more or less independently, distinct aspects of the integrated financial plan model. For example, in addition to the SAM module, the AI module, a simulation module, a financial strategy module and the user input module, the system may include one or more financial goal modules, for example but by no means limited to: a mortgage module; an estate planning module; a retirement module; an insurance module; and a major purchase module. As will be apparent to one of skill in the art, each module is defined by logic or rules dedicated to a specific financial aspect of the overall financial plan model, as discussed below.

For example, the financial strategy module comprises a plurality of different financial strategies that have been developed based on or are derived from industry best practices, legislative requirements, organizational-level compliance requirements, research and conversation with field experts and an expert level of understanding of the financial planning process.

Some examples of financial strategies include but are by no means limited to: “save retirement surpluses to an individual retirement account that provides tax advantages”, “adjust government benefit or pension start date”, “adjust retirement expenses”, “downsize to a rental property and invest the capital”, “downsize to a less expensive home and invest the capital”, “work part time during retirement”, “save even more for retirement”, “adjust when you retire”, “withdraw proportionally from all account types”, “limit taxable withdrawals”, “manage taxable income level”, “withdraw proportionally while preserving individual retirement account”, “top up your individual retirement account during retirement”, “redeem low-tax investments first” and “take advantage of individual retirement account”. Other suitable financial strategies will be readily apparent to one of skill in the art given these and other examples provided herein and are within the scope of the invention.

As will be appreciated by one of skill in the art, the nomenclature used in regard the financial strategies herein may include terms such as “TFSA” or “tax Free Savings Account”, “IRA” or “individual retirement account”, or “ISA” or “individual savings account” as examples of specific individual retirement accounts that provide tax advantages; “CPP” or “Canadian Pension Plan” and “OAS” or “Old Age Security” or “Social Security” or “State Pension” as examples of government pensions or benefits; “RSP” or “Retirement Savings Plan” or “401K” or “Self-Invested Pension Plan” as examples of pre-tax investing retirement plans; and “RESP”. “529” or “University Savings Plan” as examples of education investment vehicles. However, equivalent and/or similar programs are provided in other countries which will be readily apparent to one of skill in the art with knowledge of financial systems in those specific countries.

The mortgage module may include rules regarding repayment of mortgages, including options to refinance, pay off early, and increase or decrease frequency of payments and/or payment amounts.

The major purchase module may include different rules and restrictions for different types of purchases. As will be appreciated by one of skill in the art, some major purchases, such as a vacation, are expenses that are not assets; other major purchases, such as a vacation home, are likely to appreciate in value as an asset, whereas other major purchases, such as some types of vehicles, are likely to depreciate in value over time.

The insurance module includes for example rules regarding purchasing of life insurance based on industry best practices which will be well known by those of skill in the art.

The education module may include for example rules regarding contributions to education savings plans.

As discussed above, in use, the financial planning system receives one or more inputs from the user, who may be an end-user or client, or who may be a financial planner or advisor. That is, as defined herein, the “user” is the person who enters data and interacts with the financial planning system. The “client” is the person for whom the financial planning system generates the financial plan and whose data is entered. While referenced herein in the singular form, it is important to note that in some cases, the user is the client, but this is not necessarily always the case. In some cases, the “user” may be a financial planner or advisor. In some cases, the “client” may be more than one person, for example, two or more individuals with at least some joint finances, such as for example a couple or a family unit. In these cases, the financial planning system may generate individual reports for each client and/or may generate joint reports.

As a first step, the user selects which financial goals will be part of the financial plan, that is, which financial goal modules are to be consulted for generation of the financial plan.

These financial goals may include but are by no means limited to one or more of the following: home purchase; estate planning or a legacy; retirement; insurance; a major purchase; and education.

The user then provides personal information of the client(s) to the financial planning system, for example, by entering information in response to prompts generated by the client input module. As discussed herein, the AI module and/or the SAM module consider the entire client household demographics as part of the ranking and prioritization of the next best financial decision, as discussed below. This includes but is by no means limited to the age of the client, number of dependents and ages thereof, their physical location (country & state/province), current salary, projected retirement age and their holistic financial goals.

As will be apparent to one of skill in the art, this demographic information may be used to generate a number of assumptions about the client and/or for determining one or more projections, as discussed herein. For example, the AI may consider likelihood of future dependents, future changes in income or the like.

Specifically, the geographic location of the user is used by the taxation module for determining for example provincial or state income tax rates or any other local legislation that may have tax consequences.

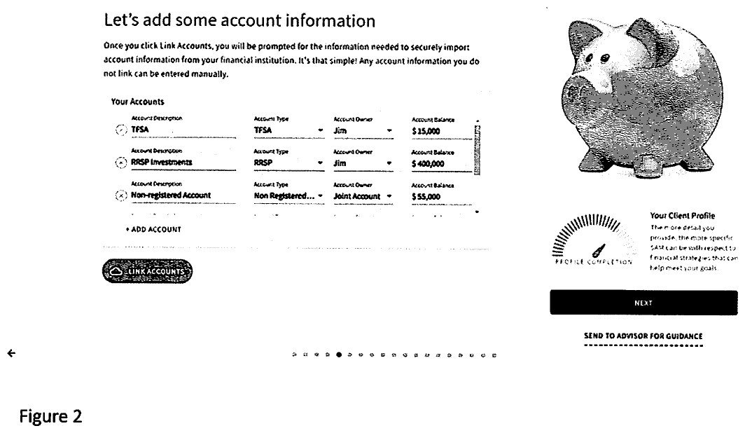

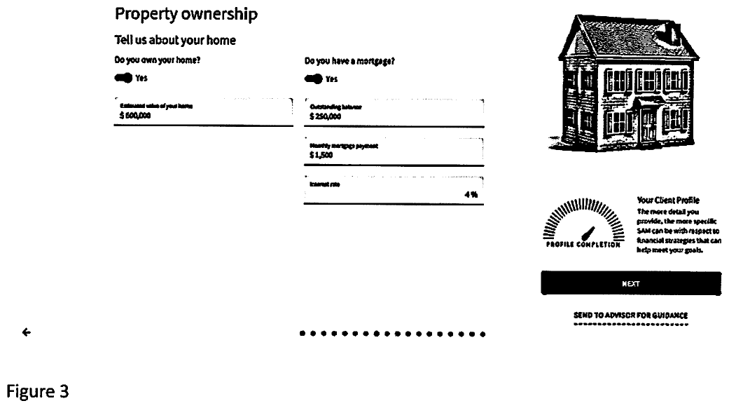

Next, the user provides information to the financial planning system relating to the current financial situation of the client. As will be appreciated by one of skill in the art, this information may include but is by no means limited to current assets and liabilities, for example, salary, investments, savings, recurring expenses, property owned, mortgages, loans and the like. Examples of the entry of such information can be seen at least in FIGS. 2 and 3. In some cases, this information may be entered manually by the user and/or the client may allow access to one or more client accounts maintained at one or more financial institutions and/or the client input module may query one or more databases or financial institutions to ask whether the client has any account(s). In these cases, such an inquiry is preceded by approval from the client to make such an inquiry and/or the other financial institutions must have the customer's approval to release any information about the customer.

In those embodiments wherein the financial planning system has access to the client's accounts, the financial planning system may analyze the accounts for recurring transactions, for example, salary, mortgage payments, retirement savings contributions, education fund contributions, savings contributions and the like.

Next, the user provides client financial sentiment information.

As discussed herein, the financial planning system supports the ability for the user to provide client sentiment or personal profiling questions such as their willingness to make specific sacrifices to achieve their goals. These questions may also be considered “lifestyle” or “financial attitude” questions.

For example, in some embodiments, the client may be asked one or more but by no means limited to one or more questions selected from the group consisting of: projected retirement lifestyle; tolerance for investment risk; willingness to save tax refunds; willingness to delay retirement; willingness to reduce retirement spending; willingness to save more now by spending less now; and willingness to downsize in retirement.

As discussed herein, while different questions may be asked for different goals, in general, the questions determine what changes to their present and/or future lifestyle that the user is willing to consider.

Furthermore, the lifestyle or sentiment data may be entered by any of a variety of means, for example, by using slider bars indicating percentages or by selecting one of a series of options wherein for example one option indicates “extremely unlikely” and each subsequent option is an increment towards the final option of “extremely likely”.

As will be apparent to one of skill in the art, other suitable sentiment questions will be readily apparent and such questions can be incorporated into the user input module.

The client sentiment and risk tolerance provide the SAM module with additional context when evaluating the next best financial decision for the holistic financial plan, as discussed below. In some embodiments, the client financial sentiments or client lifestyle sentiments may be modified by the AI module, as discussed herein.

As can be seen in the accompanying figures, this information may be entered by a variety of means, for example, by text boxes, by drop-down menus, by selection of one value from a series of values or by adjustable sliders.

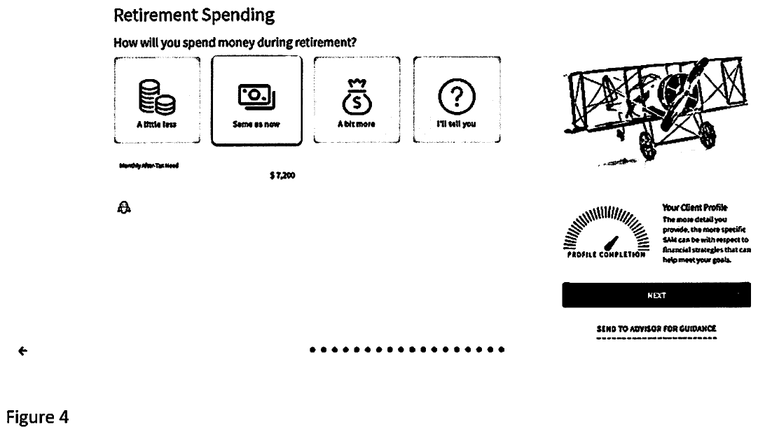

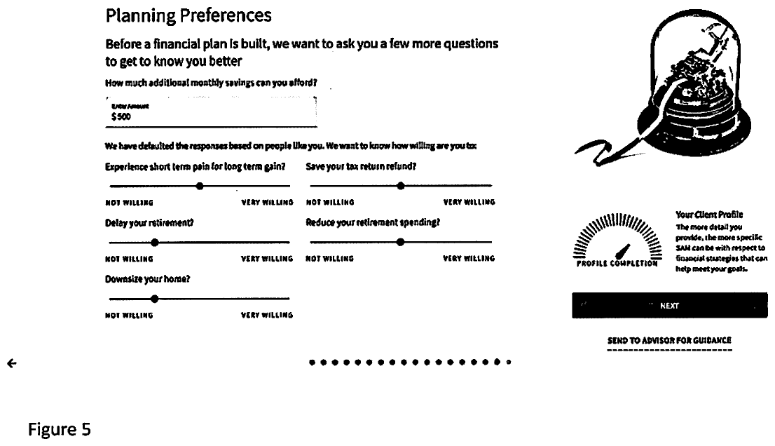

Examples of how these questions are presented can be found in FIGS. 4 and 5. For example, in FIG. 4, the user selects one of four options. In FIG. 5, the client uses slider bars to indicate preference for certain options. Other suitable arrangements for data entry will be readily apparent to one of skill in the art.

As will be apparent to those knowledgeable in the area of financial planning, “personal financial sentiments” can be very difficult for the client to accurately quantify, let alone the advisor. That is, choices that have impacts on current lifestyle have perceived costs which can vary considerably between individuals. Furthermore, in some cases, the clients themselves may mis-quantify their sentiments, as discussed herein.

However, as discussed herein, the financial planning system may comprise a machine learning module or artificial intelligence module configured to learn from previous financial plans. For example, in some embodiments, the artificial intelligence module is arranged to analyze previously generated financial plans for commonalities, particularly between client demographics, sentiment and selected financial plans. For example, the artificial intelligence module may determine that individuals in a certain age (20s) and income bracket may believe that they are willing to downsize their home to fund their retirement but the artificial intelligence module may determine that individuals within that projected income bracket often elect later in life to spend less during retirement rather than downsize in retirement and accordingly the AI module may apply a greater “cost” to downsizing than entered by clients within this demographic. Alternatively, the AI module may detect that clients with certain sentiments regarding increasing saving in the immediate future have similar spending habits in retirement or that certain responses are connected to a preference to save a tax return compared to increasing monthly contributions or vice versa.

For example, the AI module may determine appropriate ages for retirement, taking a pension or other old age benefits or timing of downsizing for maximum beneficial impact on a retirement plan. As discussed herein, in some embodiments, the AI module may determine the “best” time for decisions such as these by carrying out a plurality of projections and determining the best plan in accordance with client sentiments. That is, the AI may run a series of simulations where retirement age is varied by a specific increment such as for example by year or in increments of 3 months. Similarly, the AI may run simulations to determine the impact of downsizing at specific points in time. As discussed herein, the AI is also configured to analyze the client financial sentiment or lifestyle responses and compares the desired lifestyle in retirement to the projected lifestyle in retirement which is used to present the client with options for earlier retirement and/or increased spending in retirement. Alternatively, in some embodiments, the AI module learns from previous clients what ages clients with particular profiles are most comfortable making specific lifestyle decisions, such as downsizing. In other embodiments, this information may be based on industry best practices and/or financial industry data and best practices.

While these steps for gathering client information have been recited in a particular order, it is important to note that the order in which the financial planning system receives the information, as well as the order in which respective modules analyze the inputs, is not critical to the invention and can be varied within the scope of the invention.

With this information, the SAM module considers the net worth of the household (including the investment accounts) for example by using the simulation module, and projects their financial position to the end of the query time period, which may be today, the end of the current year or any other suitable time period, for example, to retirement age or to the end of the client lifetime. A household could be considered mass market (less than $100 k in investment accounts), mass affluent ($100 k to $1M), high net worth ($1M to $5M) or ultra-high net worth (over $5M).

This information is also used when calculating financial plans, as discussed below. For example, as will be appreciated by one of skill in the art, a decision for a household in the mass market group will be different than the next best financial decision for a household in the ultra-high net worth group. In the mass market, there is reliance on government pensions and cash flow management whereas an ultra-high net worth household would be focused on tax-efficient withdrawals and maximizing the legacy (net estate). The AI module takes these factors into account as well when selecting financial strategies, as discussed herein.

As will be appreciated by one of skill in the art, the AI module uses this combination of client-entered hard data, for example, demographic data like age, marital status, and location; and data relating to current financial circumstances like savings, investments, mortgages, other assets and liabilities and income; client-entered “soft” data relating to client sentiment on what can be considered financial attitude or lifestyle questions, such as willingness to save more at the present time, risk tolerance, willingness to downsize in retirement or willingness to spend less in retirement; and in some embodiments assumptions on likely lifestyle choices such as age at which down-sizing or reduction in spending are likely to develop a client profile. This client profile is used to predict a “perceived cost” from the client for a particular financial strategy, as discussed herein.

Furthermore, best financial decision for an “accumulator” that is a number of years from retirement will be different than the best financial decision for a household that is preparing to enter or is already in the retirement phase.

In addition, the nature of the financial goal is considered by the financial planning system, specifically, by the AI module. As discussed herein, in some embodiments, this may be based on information based on previous clients. That is, some goals, such as retirement income by age 65 may be considered to be more essential and may have a longer time frame than a major purchase which may be considered to be more of a discretionary purchase or a purchase that could be made for a lesser amount or at a different time. These and other factors are considered by the AI module when selecting the next best financial strategy, as discussed herein. That is, some strategies are more suitable for longer time frames while others are more suitable for financial goals like major purchases which can be altered but not for financial goals that may be viewed as more essential, such as education or retirement.

In some embodiments, the financial planning system is arranged so that the user can prioritize different financial goals, that is, so that education payment planning takes precedent over retirement planning or so that retirement planning and education planning are equally important but major purchases and/or legacy planning are given a lower priority, as discussed herein.

In some embodiments, the SAM module or the AI module may consult a past client database for demographic profiles of one or more previous clients with similar demographic characteristics. The SAM or AI may then consult the entries for these similar previous clients and may use the information therein to make assumptions regarding the current client's goals, priorities, and behavioral characteristics. For example, as discussed above, the artificial intelligence module may conclude that people, that is, previous clients, with at least some of the same demographic characteristics as the current client save $XXX/month, are risk adverse, and/or do not want to sell the existing home to fund retirement). It is important to note that these demographic characteristics are not simply age, but may also include location, income and client financial sentiments, that is, client lifestyle sentiments.

With this information, the SAM module or AI module then determines appropriate setting defaults for one or more parameters, for example but by no means limited to one or more of: how much to save, how many years to the projected expense or financial goal, for example retirement, projected rate of return (tied to client risk tolerance), and contribution limits where appropriate. As discussed above, this is done by carrying out a series of simulations wherein the timing of specific events, such as retirement age, downsizing, timing of specific purchases and the like.

That is, the SAM module does an assessment of the client's wealth segment and age. For example, with savings, its about what the client has specified (through sentiment) what they are willing to save and not about finding a break-even savings value (for example: $3000 a month for 25 years).

As will be apparent to one of skill in the art, these parameters predicted by the artificial intelligence module and the parameters entered by the client via the client input module comprise the client financial plan parameters. It is of note that in some embodiments, the parameters entered by the client may be modified by the artificial intelligence module based on demographic data, as discussed herein. It is however important to note that the user also has the option to re-enter and/or alter client inputs at any time, as discussed herein.

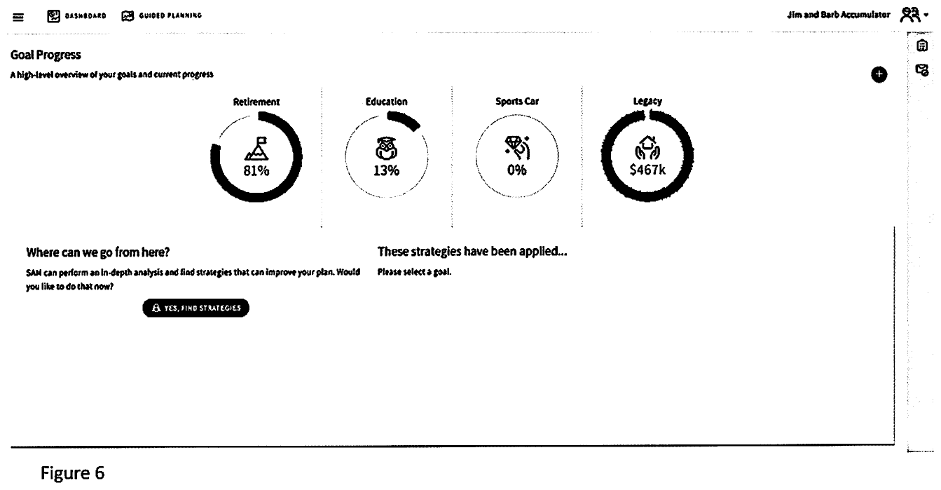

Based on this initial information, a first financial projection is generated by the SAM module providing the client parameters defined above to the simulation module. The user is then presented with an output showing what percentage of the selected financial goals that are the subject of the financial plan being generated are projected to be met without intervention. An example of this is shown in FIG. 6. As can be seen therein, in this example, based on the calculations of the SAM module, without employing a new financial plan, the client will be able to reach 81% of their retirement goal but is not meeting the other financial goals.

The SAM module then submits the client parameters to the appropriate financial goal module. As discussed above, the client parameters are analyzed by the selected financial goal module in view of the rules and restrictions associated with the selected financial goal module and the resulting goal modified parameters are submitted to the SAM module. The SAM module then submits the goal modified parameters to the simulation module and the simulation module applies each one of the financial strategies in the financial strategy module to the goal modified parameters, thereby generating a financial strategy model for each financial strategy in the financial strategy module, thereby generating a set of financial strategy models or financial plan models.

Each respective one financial strategy model of the set of financial strategy models is then ranked and prioritized and evaluated based the efficacy of the strategy through ranking criteria based on constraints and objectives, as discussed herein, in addition to weighing and calculating the impact on the overall or holistic financial plan, thereby providing a “cost and benefit” score that allows all the applicable strategies to be ranked such that the top ranked strategy represents the next best financial decision for the client.

That is, the SAM module adds each financial strategy with the client parameters to the simulation module and projects the impact implementation of each respective one financial strategy will have on the financial plan outcome over the timeframe, for example, over the client's lifetime or until the client reaches retirement age if the financial goal is retirement or until a dependent starts post-secondary education if the financial goal is education. The SAM module then extracts one or more Key Performance Indicators (KPIs), discussed below, from each simulation to illustrate the impact (positive or negative) of the respective one financial strategy on the client's financial plan. The SAM module then evaluates the efficacy of each respective financial strategy on attaining the selected financial goal(s) as well as the overall client financial plan using the KPIs and ranking criteria (client constraints/objectives).

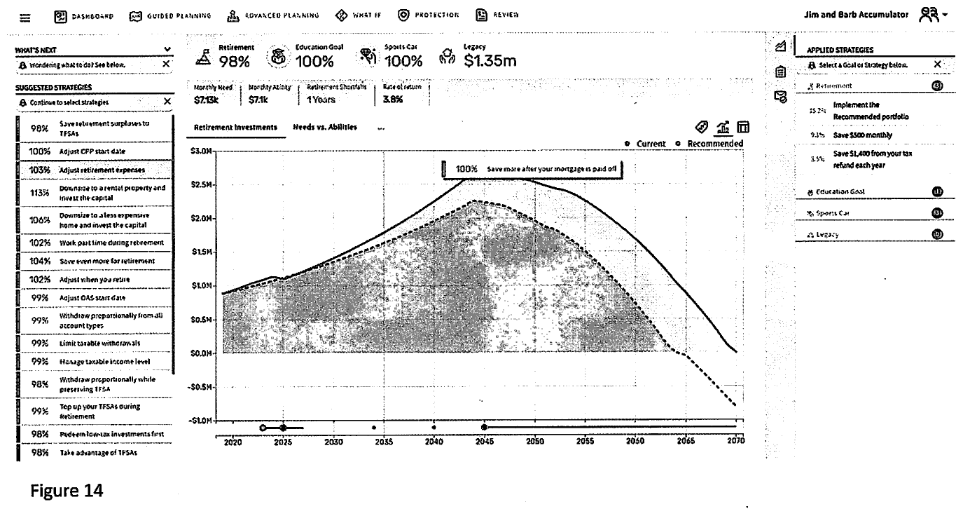

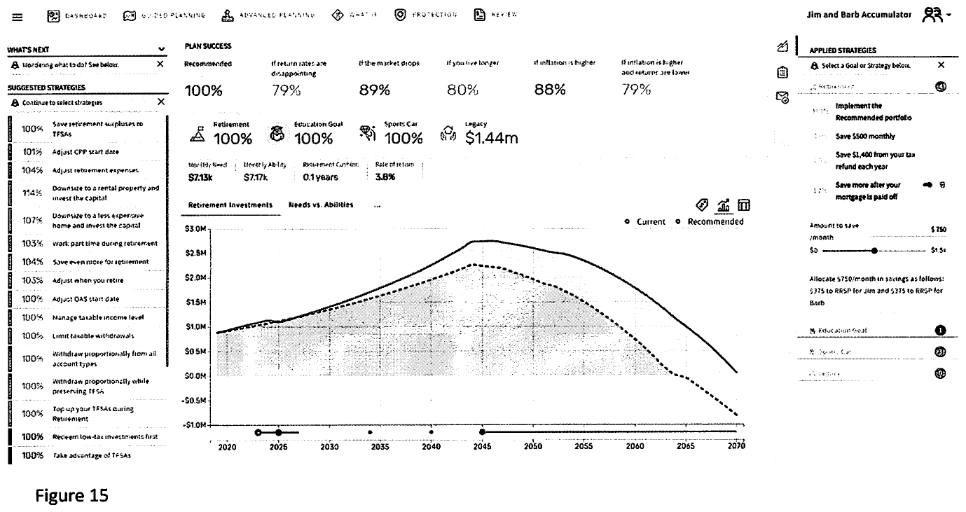

In some embodiments, the status of each financial goal in the financial plan may be calculated at intervals, for example, at each year of the client's projected lifespan and displayed to the client, as shown in FIGS. 14 and 15.

For example: the SAM module may rank a strategy to move to a new asset allocation portfolio as the next best financial strategy. Assuming the Retirement Goal Progress percentage is initially 75%, as part of representing that strategy as the next best financial decision, the financial planning system would display 95% under the assumption (in this example) that moving to a new asset allocation portfolio will increase the Retirement Goal Progress by 20% from 75% to 95%.

Examples of how this progress towards the financial goal may be displayed are shown in FIGS. 6-13. However, other suitable methods for such a display will be readily apparent to one of skill in the art and are within the scope of the invention.

An example of the ranking of the financial strategies is shown in FIG. 14. As can be seen therein, in this example, each of the financial strategies are ranked according to their impact on the financial goal(s) and/or on the holistic financial plan. Specifically, the SAM module has calculated the impact of each financial strategy and ranked the list (in this case using Goal Coverage as the KPI). As discussed herein, it is important to note that in addition to the KPI and the impact on the individual financial goals and/or the holistic financial plan, the financial strategies are also ranked according to likely perceived cost, as discussed herein.

In some embodiments, an impact percentage is presented to the user which represents the delta of the current progress percentage for a financial goal.

Thus, as discussed above, the financial strategy selected by the AI module, also referred to as the next best financial decision, is applied to the plan, and through the use of ‘Key Performance Indicators’ as well as various financial planning focused graphs & tables, the user is alerted in real-time, of the holistic impact of applying the financial strategy in real-time.

For example: if a financial strategy to move to a new asset allocation portfolio is applied to the plan, the user is presented with ‘Key Performance Indicators’ such as the ‘Return Rate’ or ‘Total Investments at Retirement’, both of which are updated in real-time, to show the client the effect that comes from adopting this financial strategy. At the same time, the system can provide a graphical representation such as an area-graph displaying the end-of-year value of all investments in the plan comparing with and without the financial strategy applied, as shown in FIGS. 14 and 15.

In this manner, as new financial strategies are suggested and/or adopted the plan is re-evaluated and the KPIs, graphs and other calculated entries are updated, for example, in real time. The user is then given the ability to modify the strategy settings from the initial values set by SAM module, for example, to save more or less, move the retirement ages or accept the recommendation, thereby allowing the user to see changes to the financial plan and in particular to the individual financial goals, in real time. This process is repeated for each of the financial goals.

In this manner, the SAM module and/or the AI module are able to perform strategy impact assessment as well as the ranking and prioritization in real-time. As financial strategies are applied to the plan, the SAM module will continually re-rank & re-prioritize the financial strategies, also in real-time, using the same process as outlined above in the earlier sections of this document. As will be appreciated by one of skill in the art, the selection of one financial strategy may change the impact of another financial strategy and by virtue of the constant re-ranking of the financial strategies, the AI module is able to detect new financial strategies that are now likely to be more attractive to the client as well as discard strategies that will no longer have a significant impact.

For example, while increasing savings may not be suggested if a client has indicated that they are not willing to spend less in the short term, adopting a financial strategy that results in a tax saving would be recognized by the AI module as a source for additional savings that did not affect current spending.

As discussed herein, the user entry module can be accessed at any time for changing for example client sentiment.

Furthermore, the client-entered data, client profile and financial plan can all be saved and/or stored by the financial planning system. As a result of this arrangement, the financial plan can be updated and/or changed as desired, for example, as part of an annual review, as client circumstances change or if certain financial strategies are found to be difficult to follow by the client.

That is, the new financial plan is presented to the user by updating the values presented to the user in real-time (i.e., without a noticeable delay between the time the user adjusts a parameter and the time the new retirement plan is presented).Thus, the AI module runs all the financial strategies using demographics, financial information and the sentiment so that the strategy (or next best financial decision) that moves the client closest to the financial goal being queried is presented first. The strategies are then applied to the holistic financial plan, but the user (client or advisor) has the ability to turn them on/off, that is, to accept or reject the plan. For example, FIGS. 6-13 show the SAM module applying the next best financial strategy in sequence to the holistic financial plan In contrast, FIGS. 14 and 15 show an option where the user is the advisor who has the option of viewing the whole list of ranked financial strategies and selecting which financial strategies to apply.

In some embodiments, the AI module learns what strategies are most attractive to clients over time based on what strategies are applied. As will be appreciated by one of skill in the art, this may represent financial strategies that are most frequently ranked highest based on KPIs and/or client sentiment and/or which financial strategies are most often selected by the user. This will help the AI module in the future with that analysis.

In one embodiment of the invention, there is provided a method for training an artificial intelligence to develop a financial plan for achieving one or more financial goals, said method comprising:
a) issuing, over a network, a stream of questions to a user computing device;
b) receiving, over the network, a stream of inputs for a financial plan module in response to the stream of questions, at least a first subset of the stream of inputs defining one or more financial goals, a second subset of the stream of inputs defining client lifestyle preferences and a third subset of the stream of inputs defining client financial information;
c) executing the financial plan module to generate a first financial plan comprising the one or more financial goals using the stream of inputs;
d) displaying the first financial plan to the user;
e) running an artificial intelligence engine, said artificial intelligence engine:
f) analyzing the stream of inputs and determining client lifestyle parameters from the client lifestyle preferences;
g) accessing each respective one of a series of financial strategies and executing the financial plan module to generate a respective one of a set of modified financial plans, each respective one of the set of modified financial plans representing the first financial goal as modified by the respective one of the series of financial strategies;
h) assigning a score to each respective one of the set of modified financial plans based on an increase in said respective one of the set of modified financial plans relative to the first financial plan and a cost of the corresponding respective one of the series of financial strategies based on client lifestyle parameters; and
i) ranking each respective one of the set of modified financial plans relative to each other based on said respective score; and
j) selecting a highest ranked modified financial plan of the set of modified financial plans; and
k) modifying the display to show the highest ranked modified financial plan,
l) at the user computer device, said user accepting or rejecting the highest ranked financial plan, wherein:
if the user rejects the highest ranked financial plan, modifying the display to show the next highest ranked financial plan;
if the user accepts the highest ranked financial plan, asking the user if the financial goal has been met, wherein:
if the first financial goal has not been met, setting the accepted highest ranked financial plan as the first financial plan and repeating steps (e) to (l) until the financial goal has been met,
characterized in that said artificial intelligence engine is configured to learn knowledge about general financial plan preferences from past ones of client financial plans and apply the learned knowledge to future ones of client financial plans.

The artificial intelligence engine may be configured to analyze past ones of client financial plans for commonalities between the client financial information, the client lifestyle preferences and the highest ranked financial strategies. That is, this analysis will provide the financial planning system with information regarding which financial strategies are ranked highest under specific client parameters. It is of note that the artificial intelligence engine may also be configured to review past plans to determine what financial strategies are most often accepted by clients in general and/or clients with certain profile characteristics as well as what financial strategies are most often rejected.

The artificial intelligence engine may be configured to analyze past ones of the client financial plans for commonalities between the client financial information and the client lifestyle preferences. As will be appreciated by one of skill in the art and as discussed herein, this information may be used to modify certain client profile parameters.

The artificial intelligence engine may be configured to analyze past ones of the client financial plans for respective ones of the financial strategies that result most frequently in the highest ranked financial plan.

The artificial intelligence engine may be configured to analyze past ones of the client financial plans for respective ones of the financial strategies that result most frequently in the highest ranked financial plan for past client lifestyle parameters similar to one or more of the current client lifestyle parameters.

Other configurations of the artificial intelligence engine wherein the artificial intelligence engine or module learns from and/or modifies the stream of inputs are discussed herein.

The embodiments described herein may be implemented using a financial planning system, described in further detail below. The system includes front end components and back end components, communicatively connected through a network. The front end components may be disposed within a computing device operated by a user, which may include a display and a controller or data entry means with a microprocessor and a program memory. The back end components may be disposed within one or more servers, each including a processor and a program memory. Each server may further include or be communicatively connected to one or more databases.

It will be understood by those skilled in the art that the components discussed herein are merely representative of particular aspects of the user computing device, and that other components that are typically included in such a device have been excluded in this description only for succinctness. Furthermore, those skilled in the art will understand that the user computing device may be successfully used with the various examples described herein even when some components are omitted.

For example, select components of a server data processing system are discussed but it is important to note that these components are merely representative, and that some of these components may be omitted or substituted while still achieving successful operation of the embodiments and examples described herein. For example, components similar to those of the user computing device include but are by no means limited to one or more processors, memory, storage devices, input and output devices respectively, and communication subsystems. The appropriate selection of components for a server system will be known to those skilled in the art. While the server system may include local storage devices, data processed or managed by the server may be stored remotely from the server system, for example in a data storage system.

As discussed herein, the advantage of the instant system is that by digging into the individual scenarios and constantly re-ranking the financial strategies as the holistic financial plan evolves, the AI presents the best possible financial strategies to achieve those financial goals. Furthermore, as discussed herein, the plan can be updated as needed with relatively minimal effort, for example, as part of an annual review by updating financial information, or by adding or deleting specific financial strategies within the plan due to client preferences and/or experiences.

A financial advisor who has seen the financial planning system made the following three observation about the SAM module and the ‘next best financial strategy’ approach and why Applicant's invention represents something different than the prior art:

1. The AI module presents contextual strategies to advisors that they would never had considered based on who the client is (Demographics), what they have (financial data), their goals and their personal preferences (client sentiment). That is, the AI has no biases in favor of or against specific financial strategies for specific types of clients and reviews all financial strategies equally.

2. In traditional planning software, advisors tend to avoid certain strategies due to the effort and time required to model strategies and test them against plan. In contrast, the SAM module will present the best strategies and settings to the advisor while testing all of the financial strategies in real-time.

3. The AI continues to build upon itself, constantly finding the ‘next best financial strategy’ for a plan. In competitor tools, this is typically done by “trial-and-error” and is a barrier to providing holistic plans. That is, prior art methods change parameters until “something good” happens.

Accordingly, the problem to be solved by the invention can be considered to be a method for providing a better financial plan. As discussed above, this is achieved through an AI module that tests each one of a large set of financial strategies for achieving a specific financial goal as part of a larger and developing financial plan. The plans are re-ranked each time one financial strategy is adopted and are re-applied as each new financial goal is analyzed. As discussed above, professionals within the financial planning field have stated that they do not apply all financial strategies in this manner because of the time and effort involved in some cases and in other cases because of biases against certain strategies and/or lack of knowledge of other strategies. The AI is also configured to search for possible changes to the holistic plan, including possible future lifestyle changes for the user.

In effect, the preparation of a suitable financial plan is akin to assembling a puzzle. In the prior art plans, an advisor puts together familiar pieces that may not fit together for the client, that is, that do not form a picture. However, in Applicant's invention, because of the holistic approach and the use of the AI, the puzzle is put together by ranking and prioritizing to display the next best piece. This is possible because the AI has been configured to analyze all possible options when developing the financial plan and continuously re-ranks the financial strategies. For example, the AI knows that delaying a pension only makes sense where there are suitable investments to draw from AND the clients live to a certain age. Other examples of the analysis carried out by the AI are discussed herein. In this manner, the financial planning system is able to put together a financial plan for the user that unlike the prior art methods forms a holistic “picture” specific for that user.

The invention will now be further explained and/or elucidated by way of example; however, the invention is not necessarily limited to or by the example.

### EXAMPLE 1

In this Example, reference is made to the accompanying figures, wherein:

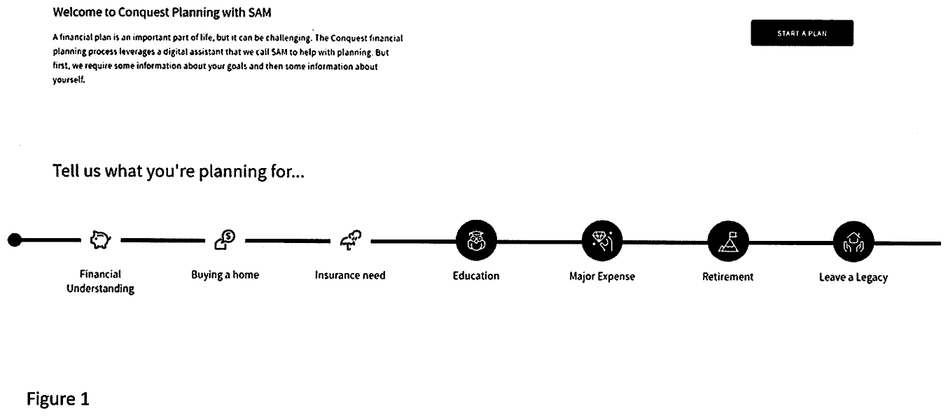

The combined information about the Clients provided via the screens outlined in FIGS. 1-5 represent the minimum data required by the SAM module to generate the next best financial strategy.

FIGS. 6-13 represent the Client Dashboard and display a scenario where the Clients are leveraging the SAM module and the artificial intelligence module to get the next best financial strategy relevant to their financial situation for each of their financial goals.

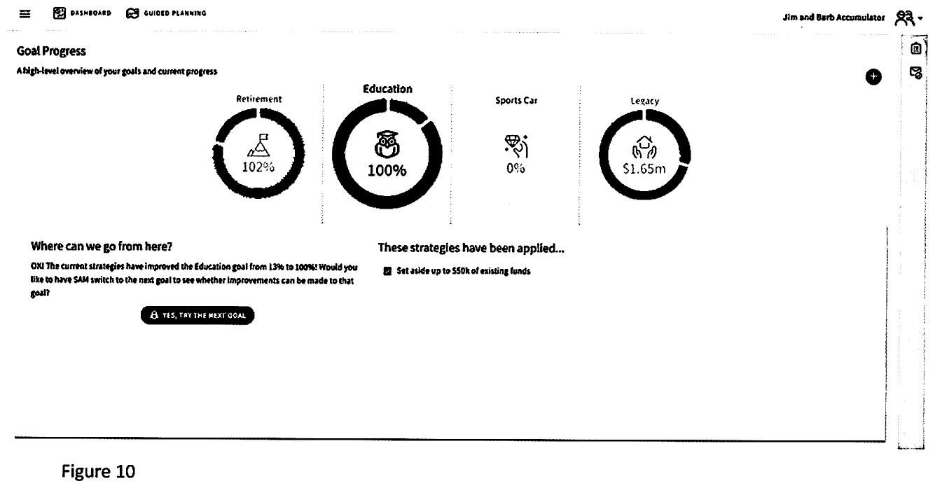

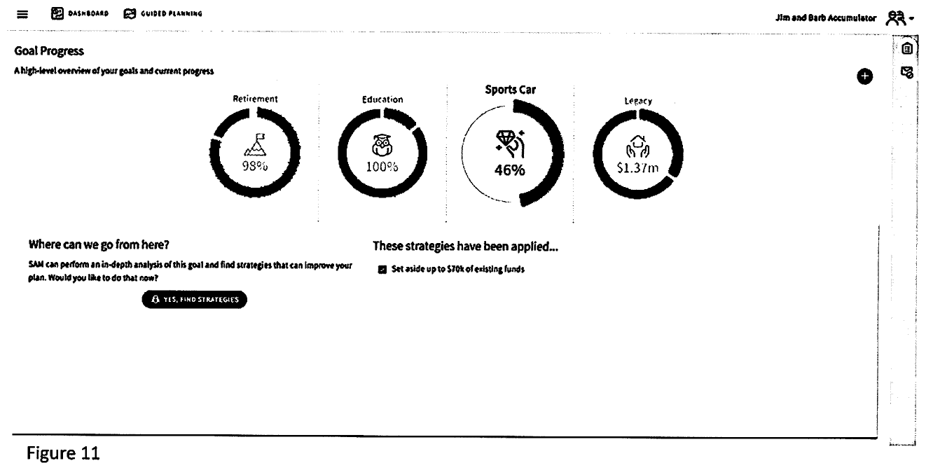

Specifically, FIGS. 6-9 illustrates the determination of the best financial strategies for the financial goal of funding retirement; FIG. 10 illustrates the determination of the best financial strategy for the financial goal of funding education; and FIGS. 11-13 illustrate the major expense goal of purchasing a sports car.

FIGS. 14 & 15 represent the financial advisor's view of the financial plan overview, for example, if the Clients, after having generated financial strategies for their situation, have reached out to their advisor for additional support with their financial plan.

In this Example, Jim and Barb Accumulator (the ‘Clients’) have requested generation of a financial plan for achieving one or more financial goals.

For this, the Clients need to provide financial and personal information, as discussed herein. In this example, the Clients have been sent a Digital Data Gathering form by their financial advisor.

Specifically, FIGS. 1-5 provide an example of one embodiment of a Client-initiated Experience, where the Clients have been asked by their Advisor to provide details on their financial goal objectives, their current financial outlook, and their willingness and preferences for certain scenarios, referred to herein generally as “client lifestyle sentiment” or “client financial sentiment”. As will be appreciated by one of skill in the art, “current financial outlook” can refer to the current financial situation of the client and/or their current projected financial outlook, based on not making any changes to their current planning.

Referring to the figures, FIG. 1 is an example of the screen where the Clients will identify their financial goal objectives. As can be seen, in this example, the client can select a financial plan that includes financial goals such as “Financial Understanding”, or an over-view of the current and/or projected financial situation; “Buying a Home”; “Insurance Need”; “Education”; “Major Expense”; “Retirement” and “Leave a Legacy”. As can be seen, and as discussed below, in this example, the Clients have selected Education, Major Expense, Retirement and Leave a Legacy as their financial goals.

The Clients are also prompted to provide demographic information, including but by no means limited to their gender, date of birth and location (residence) for themselves and any family members to be included in the plan. In this example, the clients have one child who is 15.

Shown in FIG. 2 is one example of financial planning system requesting financial information from the Clients. In this example, the Clients authorize direct access to their financial institutions for providing details on their investment, chequing and savings accounts.

Shown in FIG. 3 is one example of how the Clients identify if they have a residence and if there is a mortgage. In this example, the clients own a house with an assessed value of $600,000 but have a $250,000 mortgage at 4% interest on which they pay $1500 monthly. This information could also be retrieved from their financial institution.

The Clients are also prompted to provide information on income. In this example, both Clients earn approximately $75,000 annually.

Because, in this example, the Clients have listed retirement as a financial goal, the Clients are asked at what age they intend to retire. In this Example, both clients indicate that they intend to retire at age 65.

The Clients are then asked how they envision their lifestyle changing, if at all, when they retire. One example of how this information is provided is shown in FIG. 4. In this case, they are asked if they intend to spend a little less, spend the same as now, spend a lot more or if they are unsure. In this example, the Clients indicate that they intend to spend the same as now.

It is of note that similar questions will be asked for each financial goal selected. For example, for Education planning, the Clients are asked when their child will start post-secondary education, the duration of the course of study and the approximate cost per year.

For the Major Expense planning module, the Clients may be asked what major expenses they intend to pursue or wish to consider, such as vacations, a wedding, a vacation home and/or new vehicles and when these expenses might take place. In this example, one of the Clients has indicated that he wants to buy a sports car for $150,000 in approximately 5 years.

The Clients are then asked a series of questions regarding their planning preferences and/or sentiments. An example of this is shown in FIG. 5. As can be seen, this page provides the Clients the ability to specify their willingness to make specific personal sacrifices to achieve their financial goals. In this example shown in FIG. 5, the Clients have indicated that they are neither “for” nor “against”: “experiencing short term pain for long term gain”, that is, reducing their current spending to save more; “saving their tax refund”; or “reducing their retirement spending”, that is, that they are willing to consider these options, as discussed below. However, the Clients have indicated that they are not particularly willing to consider “downsizing their home” or “delay their retirement”.

As will be appreciated by one of skill in the art, these client sentiment questions are fairly specific for Retirement as a financial goal. However, client sentiment questions for other financial goals will be readily apparent to one of skill in the art, as will other suitable Retirement financial goal questions.

The Clients are also asked their attitude about investing, that is, whether their tolerance for risk is low, average or high. As will be apparent to those of skill in the art, this is used to determine the projected Rate of Return, as discussed herein. In this example, the Clients have indicated an “average” tolerance for risk. As will be apparent to those of skill in the art, “rate of return” are industry-standard values that are used to select a portfolio that is proportional to or suitable for the stated risk tolerance.

The artificial intelligence module reviews the demographic data and the client sentiment data entered for each of the financial plans and generates client parameters which are then provided to the SAM module. The SAM module then directs these parameters to the modules corresponding to the financial goals selected, in this case, the retirement module, the education module, the major purchase module and the inheritance or legacy module.

With the client parameters, the SAM module generates an initial report that shows the user how close the client is to achieving each of their goals without intervention, that is, without adopting one or more of the financial strategies that will be suggested by the SAM module.

In this example, the goal progress without intervention for the Clients is shown in FIG. 6. That is, FIG. 6 is intended to provide the Clients with an understanding of their current financial outlook based on the data provided through the Digital Data Gathering form. As can be seen, the Clients are currently projected to reach 81% of their retirement goal by age 65 and are projected to be able to leave a legacy of $467,000 for their child. However, they are only reaching 13% of their education savings goal and have nothing set aside for their major purchase.

Next, for each financial goal selected by the user, the SAM module directs the financial planning module to model each respective one of the plurality of financial strategies stored therein, directs the appropriate financial goal module, in this case, the retirement module, to analyze each of the financial strategies according to the rules and restrictions therein and then ranks each financial strategy according to a “cost-benefit” ratio.

FIG. 14 is the Advanced Planning page of the application. On this page, the advisor is presented with additional functionality including the entire list of strategies that are ranked and prioritized based on the Clients situation, their client sentiment and other strategies previously applied to the Clients plan. In this scenario, the Advisor has decided to select the next best financial strategy for the Retirement goal of ‘Save more after your mortgage is paid off.’ SAM is aware of when the Clients mortgage is paid off, and is recommending that some of the cash flow previously used for the mortgage, be saved to the Clients investment accounts.

As can be seen, in FIG. 14, the impact of each respective one financial strategy on attaining the financial goal is shown in the left-hand column. As can be seen, the highest ranked financial strategies for this example include “save retirement surpluses to TFSAs” which will fund to 98% of the goal, “adjust CPP start date” which will fund to 100% of the goal, “adjust retirement expenses” which will fund to 103% of the goal, “downsize to a rental property and invest the capital” which will fund to 113% of the goal, “downsize to a less expensive home and invest the capital” which will fund to 106% of the goal, “work part time during retirement” which will fund to 102% of the goal, “save even more for retirement” which will fund to 104% of the goal, “adjust when you retire” which will fund to 102% of the goal, “adjust OAS start date” which will fund to 99% of the goal, “withdraw proportionally from all account types” which will fund to 99% of the goal, “limit taxable withdrawals” which will fund to 99%, “manage taxable income level” which will fund to 99% of the goal, “withdraw proportionally while preserving TFSA” which will fund to 98% of the goal, “top up your TFSA during retirement” which will fund up to 99% of the goal, “redeem low-tax investments first” which will fund up to 98% of the goal, and “take advantage of TFSAs” which will fund up to 98% of the goal.

From this, it is clear that the financial strategies that will have the greatest impact on attaining the retirement goal is for the Clients to downsize their home. However, the Clients have indicated in their planning preferences or client sentiments that they are not particularly willing to consider downsizing their home. As such, while these financial strategies have a high benefit, they also have a high perceived cost, that is, these financial strategies represent something that the Clients have indicated that they are reluctant to do.

Other financial strategies include delaying retirement which the Clients have also indicated that they are reluctant to consider. It is important to note that because of the ranking of strategies by “cost/benefit” as discussed herein, if delaying retirement will have the greatest impact on attaining the selected financial goals, this financial strategy will be presented to the client, who then has the option of accepting or rejecting the financial strategy, as discussed herein. As will be appreciated by one of skill in the art, a financial advisor would be unlikely to spend the time to determine what benefit there would be for a strategy that the client has indicated is undesirable except as a last resort. It is maintained that this demonstrates the effectiveness of the financial planning system in providing the best financial plan for clients, as discussed herein.

However, the Clients have indicated a willingness to either reduce their retirement spending or to save more in the short term, either by saving their tax refund or spending less now to have more later. As such, the perceived cost of these options is expected to be lower to the clients.

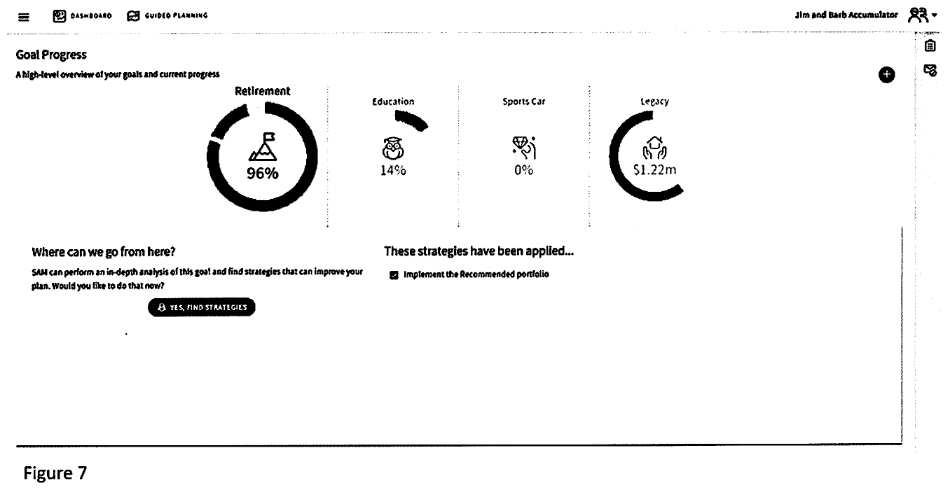

Furthermore, some of the financial strategies involve reallocation of assets and/or a change in investing strategy without changing contributions or cash flow. As will be appreciated by one of skill in the art, a financial strategy like this can be implemented at no perceived cost to the Clients. Accordingly, as can be seen in FIG. 7, this is the first strategy applied by the SAM module as it has the greatest benefit with the lowest cost, that is, a negligible cost. That is, once the Clients' mortgage has been paid off, the amount of the mortgage payment is then invested, meaning that there is no net change to the Clients' disposable income, and therefore no perceived cost.

FIG. 7 is the Client Dashboard after the Client has selected the Yes, Find Strategies button for the Retirement goal. The SAM module will direct the AI module to present the next best financial strategy for a goal. As can be seen in FIG. 7, implementation of the suggested financial strategy increases the goal progress for the financial goal of retirement funding from 81% to 96%. At this point, the user has the option of finding an additional financial strategy that will meet their financial goal or proceeding to the next financial goal.

It is important to note that although analysis of the other financial goals has not yet begun, the impact that the selected financial strategy will have on these other financial goals, if any, is displayed to the User and/or the Clients in real-time. Specifically, as can be seen, implementing this strategy of investing an amount corresponding to the previous mortgage payment once the mortgage has been paid off has only a small effect on education fund (increasing from 13% in FIGS. 6 to 14% in FIG. 7) but has a significant effect on the legacy fund, increasing that from $467,000 to $1,220,000. As discussed herein, this is considered to have a zero perceived cost because it has no net effect on the clients' lifestyle, that is, it is effectively a reallocation of the mortgage payment into savings.

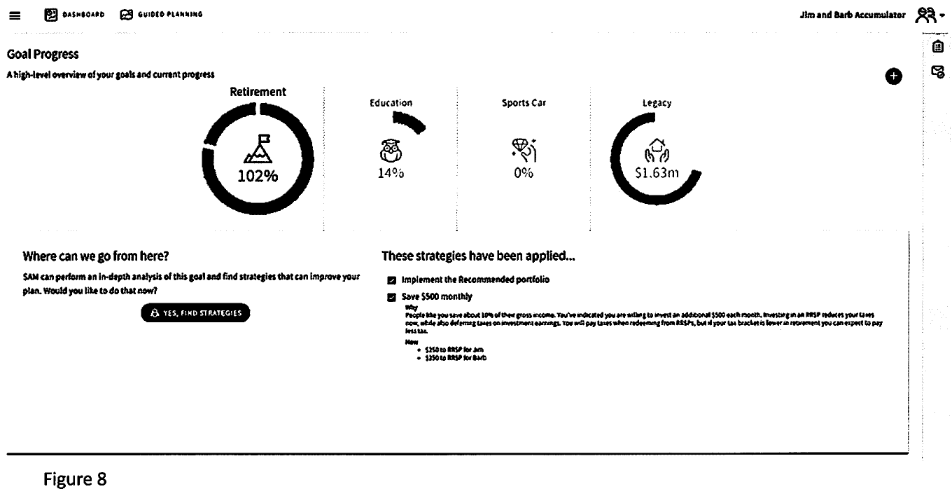

In this example, the User elects to find an additional financial strategy. In this case, the next best financial strategy is to increase savings by saving an additional $500 per month with each of the Clients contributing an additional $250 per month to their retirement savings plan. An example of what this might look like to the user is shown in FIG. 8.

Specifically, FIG. 8 displays a 2nd strategy that the artificial intelligence module returned (strategies for achieving this financial goal will continue to be displayed until the Retirement progress percentage is 100% or over). The Clients have the ability to get more information by clicking on a strategy. Financial literacy is provided as well as the action items for the strategy. Because the financial planning system is designed to use actual federal and provincial/state tax forms and uses contribution/deduction limits, some strategies will recommend specific investment vehicles to save to, for example, in this scenario, a Registered Retirement Savings Plan or RRSP.

This is shown in FIG. 8, in this example, the artificial intelligence module provides an explanation as to the benefits of this financial strategy. Specifically, the SAM module generates an output which says “people like you save about 10% of their gross income. You've indicated that you are willing to invest an additional $500 each month, investing in an RRSP reduces your taxes now, while also deferring taxes on investment earnings. You will pay taxes when redeeming from RRSPs, but if your tax bracket is lower in retirement you can expect to pay less tax.”

As discussed above, this financial strategy is selected by the SAM module as having the greatest benefit with an acceptable cost by virtue of the client sentiment data wherein the Clients indicated a willingness to accept short term pain for long term gain, as discussed above. This selection is also influenced by the artificial intelligence module, as discussed above.

As discussed above, the effects that implementation of this new financial strategy on the other selected financial goals is also displayed in real time, as shown in FIG. 8. In this case, while there is no change in the education funding, the legacy funding increases from $1,220,000 to $1,630,000.

In this example, the benefits of the artificial intelligence module can clearly be seen as the impact of changes to the holistic financial plan can be seen immediately. Furthermore, as discussed herein, the user has the option to accept a specific strategy and move to the next goal, or accept a new strategy and look for additional strategies for the same financial goal or reject the financial strategy and request the next best financial strategy. As discussed herein, financial strategies can be changed at any time when the financial planning system is in operation. Similarly, client-entered information, including client sentiment data, can be changed at any time and the impact of these changes on the financial plan seen in real time.

In some embodiments, the artificial intelligence module compares the demographic data and client sentiment data provided to the past client database and has determined what percentage of their gross income clients with similar client parameters invest. In other embodiments, this information may be derived from or rely on industry standards or best practices.

As shown in FIG. 8, in this example, by implementing the two suggested financial strategies, the Clients will reach 102% of their retirement goal.

In this example, the User requests that the SAM module model the effect of the next best financial strategy for the Clients.

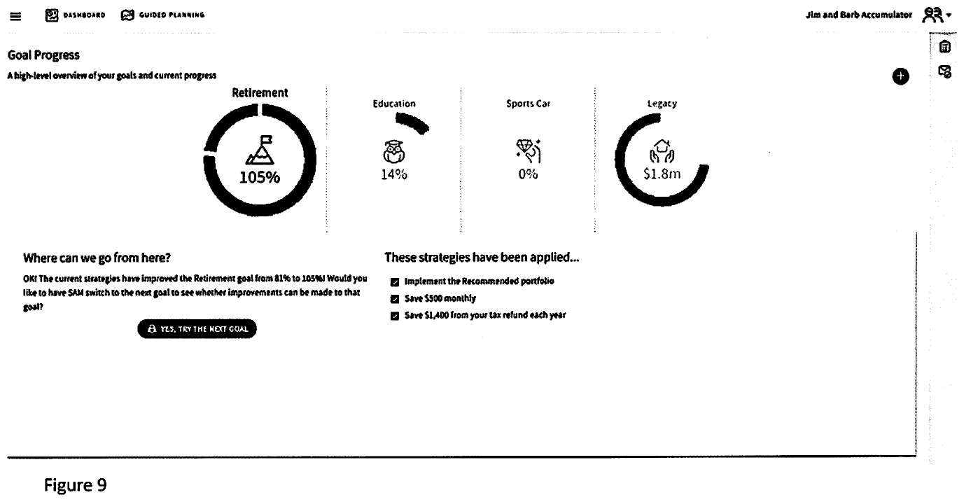

FIG. 9 displays a 3rd strategy that the artificial intelligence module has returned for the Retirement financial goal. In this scenario, because the SAM module is aware of the Clients tax situation and the previous strategy of saving to an RRSP, the SAM module, as a result of interaction with the retirement module, has generated a strategy to save the tax refund that will result from the tax deduction created by the previous strategy, that is, by investing in an RSP.

As can be seen in FIG. 9, saving $1400 from their tax refund each year will increase their funding of their retirement from 102% to 105%. As can be seen, in this case, this strategy has no effect on the education funding but increases the legacy funding from $1,630,000 to $1,800,000.

As discussed herein, the Clients have the option to reject this financial strategy. For example, the Clients may decide that the benefit of saving this money is not worth the associated “cost”. That is, the Clients can accept retirement funding at 102% and move on to planning for the next financial goal, which is funding education.

In this example, when the Goal Progress percentage (in this scenario Retirement which is now at 105% due to the 3 strategies applied by SAM) is 100% or greater, the Yes, Find Strategies is changed to Yes, Try the Next Goal.

In this case, the Clients accept this strategy and proceed to planning of the next financial goal.

Accordingly, in the next stage of the example, the SAM module directs the financial strategy module to model a plurality of financial strategies for education savings using the client parameters defined above. That is, the financial strategies modeled by the financial strategy module are then analyzed based on the rules and limitations in the education planning module.

As will be apparent to one of skill in the art and as discussed above, each of these financial goals has a different time period and may also have different rules regarding taxation during the contribution phase and/or during the withdrawal phase. Accordingly, the rules of each financial goal module must be applied to the financial strategies in addition to application of the client parameters to determine the next best financial plan for the Clients meeting their financial goal. As discussed herein, the AI module is also arranged to determine optimum parameters, for example, specific timing of certain events, as well as to detect opportunities presented by the evolving financial plan for increased savings or spending that has minimal perceived cost.

In this example, the next best financial strategy suggested by the SAM module is setting aside up to $50,000 of existing funds, that is, from the Clients' investments. An example of how this might be displayed to the Clients and/or User is shown in FIG. 10.

As can be seen, in this case, the setting aside of $50,000 of existing funds reduces the retirement funding to 102% from 105% and reduces the legacy fund from $1,800,000 to $1,650,000.

As a result of the arrangement, not only are new financial strategies for the Clients generated in real time, the impact of these financial strategies on their holistic financial plan is also evident in real time.

In this example, the Clients accept this plan and proceed to their next financial goal, a Major Purchase, in this case, purchasing a sports car.

As will be appreciated by one of skill in the art and as discussed above, the major purchase module contains different rules regarding major purchases, depending on the category of the asset, specifically, whether the asset will appreciate or depreciate in value over time.

In this example, the SAM module uses the AI module to analyze the financial strategies to determine the next best financial strategy for achieving this financial goal.

In this example, the first best financial plan is setting aside up to $70,000 of existing funds.

As shown in FIG. 11, this reduces retirement funding to 98% and the legacy fund to $1,370,000 but has no effect on education funding. This financial strategy reaches 46% of the target amount.

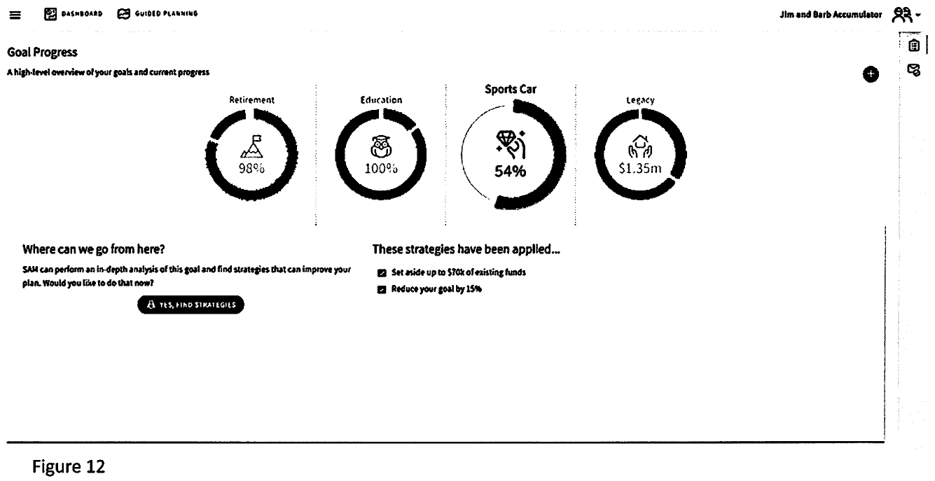

The AI module then suggests that the next best financial plan is to reduce the goal by 15%, that is, to buy a less expensive sports car. As can be seen, this has a minimal effect on the other financial plans, but increases from 46% to 54% of the target amount. This is illustrated in FIG. 12.

It is important to note that the strength of the AI module is clearly demonstrated in this scenario as well. Specifically, because the AI is aware of the client sentiments, the AI module decides that reduction of the expense is likely to be preferable to altering any of the other financial plans, especially given the Clients preference for short term pain for long term gains and their unwillingness to downsize in retirement or change their retirement age. That is, the AI module is aware that the Clients are likely to be more interested in the “big picture” or long-term goals. In some embodiments, the AI may be aware that individuals within this demographic with similar client sentiments tend to modify major purchase plans to fit in with their overall financial plan.

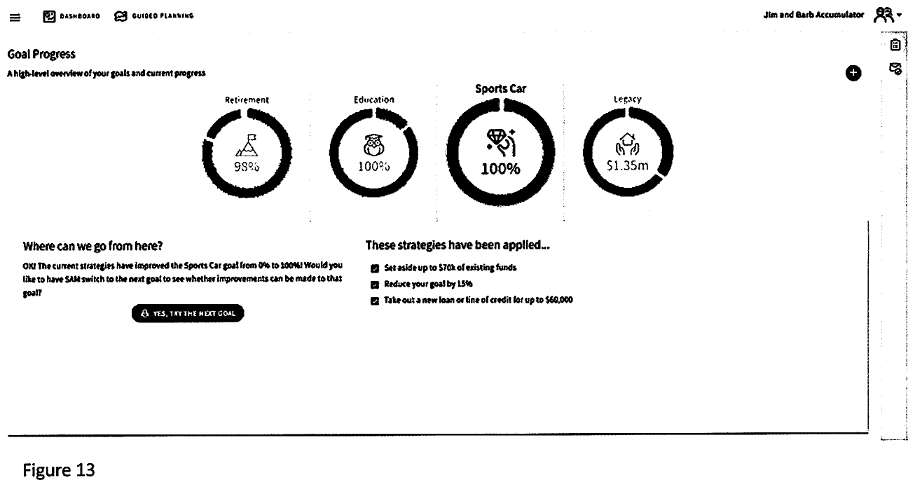

With this in mind, the next best financial plan suggested by the AI module is that the Clients take out a loan or a line of credit for $60,000 to fund the balance of the major purchase, bringing this financial goal to 100%. This is shown in FIG. 13. As can be seen, the impact on the other financial goals is also shown, in real time.

In summary, in FIGS. 11-13, the SAM module, via the AI module, is generating 3 financial strategies for the Sports Car goal objective so as to mitigate the holistic impact of the financial strategies.

Last, the financial plan is tested against a number of different stresses. As discussed above, a ‘stress’ scenario is a scenario where an external risk factor is applied to the plan as way of testing plan success, for example, what if the Clients lived longer? Other stresses that may be tested include decreases in return rates, a downturn in the stock market, an increase in inflation and the like. Shown in FIG. 15 is an example of how this information might be presented to the User. As can be seen, the User can view the view the various stress scenarios but still have access to the entire list of next best financial strategies for the Clients.

That is, the AI module can be used to modify various parameters on which the financial plan has been developed to develop ‘contingent’ strategies that can be used to mitigate the risk of that particular stress scenario. The user has the option to apply that to the overall plan strategies.

### EXAMPLE 2

In this example, a married couple, both age 65, are meeting with an advisor to determine if they have enough money to last for their entire retirement. They are both entitled to full government pension and they have approximately $3,000,000 in investments. They are currently invested in a very conservative portfolio earning about 2% return. They are willing to downsize their home, but want to know when that would make the most sense for them. They have specified that they want to maintain their current lifestyle and spend $10,000 per month. For the sake of the example, assume all relevant financial data has been loaded into the software and the client has answered a risk tolerance questionnaire for their advisor. The client has also provided responses to client sentiment questions.

Using existing tools, the steps to assess are manual and based on trial & error. The most common strategy that an advisor would apply first is to assess the clients' risk tolerance and look for an alternative investment portfolio. Since in the example clients are in retirement, the next logical step (based on advisor training and what is considered to be “best practice” within the industry) is to consider a retirement ‘order of withdrawal’. (Asset allocation before a withdrawal order isn't required in traditional tools, but instead dependent entirely on the user). This is an area where most advisors can spend hours attempting to find an ideal ‘order’. For example: Withdrawal from tax-deferred accounts (such as registered or qualified accounts) last, which is the most common.

This demonstrates how using existing advisor tools, an advisor can spend hours looking for an optimal action plan for clients. If the advisor wants to consider other strategies, such as downsizing, they have to do that manually, and have no way to assess impact to the entire plan, only the impact at the point in time they created the scenario.

As will be apparent, existing tools remain point-in-time, in that if changes in the future are required, the advisor must generate the plan again and/or apply new strategies manually.

In contrast, with Applicant's invention, using the same initial scenario, the ‘next best financial strategies’ are ranked & prioritized by the AI module. Reallocation to a new portfolio is generally the first strategy presented by the AI module (as there is a low cost/benefit to a client to invest more in-line with their risk tolerance). Once that strategy has been applied, the SAM module will re-rank and re-prioritized based on the changes in the financial outlook or in-progress financial plan based on the applied financial strategy, in this case, a portfolio reallocation strategy. All strategies inherently consider the ‘goal progress percentage’ (a deterministic needs vs abilities calculation that determines how close a plan is to achieving the specified goal objective) and display the immediate impact of a strategy, as discussed herein.

The AI will also present options such as ‘adjust retirement spending later in retirement’ (suggesting that as the clients age, their spending may be less than the $10 k per month), assess an optimal start date for their government pensions or perhaps a withdrawal plan that would A: maximize their spending during retirement and B: maximize their net estate.

Assuming that the first ranked strategy is to adjust their spending, the advisor would apply that strategy and the remaining strategies are re-ranked & re-prioritized. It is important to note here that the advisor does not have to figure out the ideal spending strategy (as the AI will recommend one) and the advisor does not have to make the adjustments manually to the plan (as the strategy itself will set the parameters).

An optimized spend rate, in this example, may lead to an optimized withdrawal plan, which is different from relying on withdrawal order, discussed above. The withdrawal plan is an optimized plan to withdrawal from the entirety of the clients' investments in an optimized method that will (as mentioned) maximize their spending during retirement and maximize their net estate. It is possible that the AI may suggest an order (such as preserve tax-free accounts), but it would be an optimized plan first and foremost.

Once the withdrawal plan is applied and accepted as the next best financial strategy, the financial strategies are re-ranked and re-prioritized. For example, the AI module may suggest delaying the start date of government pensions. Delayed government pensions generally mean an increase in total payments than if they are taken at the normal retirement age (Age 65). As known by those of skill in the art, in traditional tools, the user has to manually adjust the start age to find what works best OR they are presented with options.

The AI module will continually look for opportunities for the clients; such as insurance products that could be used to mitigate estate taxes, or registered/qualified ‘shaving’ strategies where withdrawals above the required minimums are done and saved to tax-free accounts. These strategies are determined by the AI, and are possible because of the compounding nature of the applied strategies in Applicant's invention. Specifically, as discussed herein, users are continually presented with strategies in a ranked and prioritized list. As can be seen, this continuous analysis by the AI module locates opportunities and options not possible using traditional methods, as discussed herein.

Furthermore, providing action items to a client does not stop the AI module from continuing to look for opportunities. As time goes by, and the advisor or client re-visits a plan, the AI will continually look for the ‘next best financial’ decision without having to re-enter strategies or start a new plan, as discussed above.

While the preferred embodiments of the invention have been described above, it will be recognized and understood that various modifications may be made therein, and the appended claims are intended to cover all such modifications which may fall within the spirit and scope of the invention.

1. A non-transitory computer-readable medium bearing code which, when executed by at least one processor of a computer system, causes the computer system to implement the method comprising:
a) issuing, over a network, a stream of questions to a user computing device;
b) receiving, over the network, a stream of inputs for a financial plan module from the user in response to the stream of questions, at least a first subset of the stream of inputs defining one or more financial goals, a second subset of the stream of inputs defining client lifestyle preferences and a third subset of the stream of inputs defining client financial information;
c) executing the financial plan module to generate a first financial plan comprising said one or more financial goals using the stream of inputs;
d) displaying the first financial plan to the user;
e) running an artificial intelligence engine, said artificial intelligence engine:
f) analyzing the second subset of the stream of inputs and determining client lifestyle parameters from the client lifestyle preferences;
g) accessing each respective one of a set of financial strategies and executing the financial plan module to generate a respective one of a set of modified financial plans, each respective one of the set of modified financial plans representing the financial goal as modified by the respective one of the set of financial strategies;
h) assigning a score to each respective one of the set of modified financial plans based on an increase in said respective one of the set of modified financial plans relative to the financial goal and a cost of the corresponding respective one of the set of financial strategies based on the client lifestyle parameters;
i) ranking each respective one of the set of modified financial plans relative to each other based on said respective score; and
j) selecting a highest ranked modified financial plan of the set of modified financial plans; and
k) modifying the display to show the highest ranked modified financial plan for the client to the user.

2. The non-transitory computer-readable medium bearing code according to claim 1 wherein the method comprises modifying the display to show the highest ranked modified financial plan in real time.

3. The non-transitory computer-readable medium bearing code according to claim 1 wherein the method includes the artificial intelligence modifying the display to show the respective one financial strategy corresponding to the highest ranked modified financial plan.

4. The non-transitory computer-readable medium bearing code according to claim 3 wherein the method comprises the artificial intelligence further modifying the display to include financial literacy information and/or action item(s) regarding the respective one financial strategy corresponding to the highest ranked modified financial plan.

5. The non-transitory computer-readable medium bearing code according to claim 1 wherein the method comprises repeating steps (e) to (j) to select a next highest ranked financial plan.

6. The non-transitory computer-readable medium bearing code according to claim 1 wherein the second subset of the stream of inputs comprises answers to one or more questions selected from the group consisting of: projected retirement lifestyle; tolerance for investment risk; willingness to save tax refunds; willingness to delay retirement; willingness to reduce retirement spending; willingness to save more now by spending less now; and willingness to downsize in retirement.

7. The non-transitory computer-readable medium bearing code according to claim 1 wherein the one or more financial goals are selected from the group consisting of: home purchase; estate planning; retirement; insurance; a major purchase; and education.

8. The non-transitory computer-readable medium bearing code according to claim 1 wherein the set of financial strategies comprise one or more of the group consisting of: increasing savings; increasing investing; delaying retirement age; delaying pension withdrawal age; optimizing withdrawal plans; and optimizing investment strategies.

9. The non-transitory computer-readable medium bearing code according to claim 1 wherein the set of financial strategies comprise one or more of the group consisting of: saving retirement surpluses to an individual retirement account; adjusting pension start date; adjusting retirement expenses; downsizing to a rental property and investing the capital; downsizing to a less expensive home and investing the capital; working part time during retirement; saving even more for retirement; adjusting retirement age; adjusting government benefit or government pension start date; withdrawing proportionally from all account types; limiting taxable withdrawals; manage taxable income level; withdrawing proportionally while preserving individual retirement account; saving to individual retirement account during retirement; redeeming low-tax investments first; and using an individual retirement account that provides tax advantages.

10. The non-transitory computer-readable medium bearing code according to claim 1 wherein the third subset of the streams of inputs comprises answers to one or more questions selected from the group consisting of: age of the client; number of dependents and ages thereof; physical location of the client; current salary; and projected retirement age.

11. The non-transitory computer-readable medium bearing code according to claim 1 wherein after step (k), the artificial intelligence tests the financial plan against one or more stresses and displays contingency strategies.

12. The non-transitory computer-readable medium bearing code according to claim 1 wherein during step (g), a respective one of the set of financial strategies is accessed more than once for determining optimum timing of a decision.

13. A method of preparing a financial plan for achieving one or more financial goals comprising:
a) issuing, over a network, a stream of questions to a user computing device;
b) receiving, over the network, a stream of inputs from a user for a financial plan module in response to the stream of questions, at least a first subset of the stream of inputs defining one or more financial goals, a second subset of the stream of inputs defining client lifestyle preferences and a third subset of the stream of inputs defining client financial information;
c) executing the financial plan module to generate a first financial plan comprising said one or more financial goals using the stream of inputs;
d) displaying the first financial plan to the user;
e) running an artificial intelligence engine, said artificial intelligence engine:
f) analyzing the second subset of the stream of inputs and determining client lifestyle parameters from the client lifestyle preferences;
g) accessing each respective one of a set of financial strategies and executing the financial plan module to generate a respective one of a set of modified financial plans, each respective one of the set of modified financial plans representing the financial goal as modified by the corresponding respective one of the set of financial strategies;
h) assigning a score to each respective one of the set of modified financial plans based on an increase in said respective one of the set of modified financial plans relative to the first financial plan and a cost of the corresponding respective one of the series of financial strategies based on the client lifestyle parameters; and
i) ranking each respective one of the set of modified financial plans relative to each other based on said respective score; and
j) selecting a highest ranked modified financial plan of the set of modified financial plans; and
k) modifying the display to show the highest ranked modified financial plan.

14. The method according to claim 13 wherein the display is modified in real time.

15. The method according to claim 13 wherein the artificial intelligence further modifies the display to show the respective one financial strategy corresponding to the highest ranked modified financial plan.

16. The method according to claim 15 wherein the artificial intelligence further modifies the display to include financial literacy information and/or action item(s) regarding the respective one financial strategy corresponding to the highest ranked modified financial plan.

17. The method according to claim 13 wherein steps (e) to (k) are repeated to select the next highest ranked financial plan.

18. The method according to claim 13 wherein the second subset of the stream of inputs comprises answers to one or more questions selected from the group consisting of: projected retirement lifestyle; tolerance for investment risk; willingness to save tax refunds; willingness to delay retirement; willingness to reduce retirement spending; willingness to save more now by spending less now; and willingness to downsize in retirement.

19. The method according to claim 13 wherein the one or more financial goals are selected from the group consisting of: home purchase; estate planning; retirement; insurance; a major purchase; and education.

20. The method according to claim 13 wherein the set of financial strategies comprise one or more selected from the group consisting of: increasing savings; increasing investing; delaying retirement age; delaying pension withdrawal age; optimizing withdrawal plans; and optimizing investment strategies.

21. The method according to claim 13 wherein the set of financial strategies comprise one or more strategies selected from the group consisting of: saving retirement surpluses to an individual retirement account; adjusting government benefit or pension start date; adjusting retirement expenses; downsizing to a rental property and investing the capital; downsizing to a less expensive home and investing the capital; working part time during retirement; saving even more for retirement; adjusting retirement age; adjusting old age benefit start date; withdrawing proportionally from all account types; limiting taxable withdrawals; manage taxable income level; withdrawing proportionally while preserving individual retirement account; saving to individual retirement account during retirement; redeeming low-tax investments first; and using an individual retirement account with tax advantages.

22. The method according to claim 13 wherein the third subset of the stream of inputs comprises answers to one or more questions selected from the group consisting of: age of the client; number of dependents and ages thereof; physical location of the client; current salary; and projected retirement age.

23. The method according to claim 13 wherein after step (i), the artificial intelligence tests the financial plan against one or more stresses and displays contingency strategies.

24. The method according to claim 13 wherein during step (g), a respective one of the set of financial strategies is accessed more than once for determining optimum timing of a decision.

25. A non-transitory computer-readable medium bearing code which, when executed by at least one processor of a computer system, causes the computer system to implement the method comprising:
a) issuing, over a network, a stream of questions to a user computing device;
b) receiving, over the network, a stream of inputs from the user for a financial plan module in response to the stream of questions, at least a first subset of the stream of inputs defining one or more financial goals, a second subset of the stream of inputs defining client lifestyle preferences and a third subset of the stream of inputs defining client financial information;
c) executing the financial plan module to generate a first financial plan comprising the one or more financial goals using the stream of inputs;
d) displaying the first financial plan to the user;
e) running an artificial intelligence engine, said artificial intelligence engine:
f) analyzing the stream of inputs and determining client lifestyle parameters from the client lifestyle preferences;
g) accessing each respective one of a set of financial strategies and executing the financial plan module to generate a respective one of a set of modified financial plans, each respective one of the set of modified financial plans representing the first financial goal as modified by the respective one of the set of financial strategies;
h) assigning a score to each respective one of the set of modified financial plans based on an increase in said respective one of the set of modified financial plans relative to the first financial plan and a cost of the corresponding respective one of the series of financial strategies based on the client lifestyle parameters;
i) ranking each respective one of the set of modified financial plans relative to each other based on said respective score; and
j) selecting a highest ranked modified financial plan of the set of modified financial plans; and
k) modifying the display to show the highest ranked modified financial plan,
l) at the user computer device, said user accepting or rejecting the highest ranked financial plan, wherein:
if the user rejects the highest ranked financial plan, modifying the display to show the next highest ranked financial plan;
if the user accepts the highest ranked financial plan, asking the user if the financial goal has been met, wherein:
if the first financial goal has not been met, setting the accepted highest ranked financial plan as the first financial plan and repeating steps (e) to (l) until the financial goal has been met.

26. The non-transitory computer-readable medium bearing code according to claim 25 wherein the method comprises modifying the display in real time.

27. The non-transitory computer-readable medium bearing code according to claim 25 wherein the method comprises the artificial intelligence further modifying the display to show the respective one financial strategy corresponding to the highest ranked modified financial plan.

28. The non-transitory computer-readable medium bearing code according to claim 27 wherein the method comprises the artificial intelligence further modifying the display to include financial literacy information and/or action item(s) regarding the respective one financial strategy corresponding to the highest ranked modified financial plan.

29. The non-transitory computer-readable medium bearing code according to claim 25 wherein the second subset of the stream of inputs comprises answers to one or more questions selected from the group consisting of: projected retirement lifestyle; tolerance for investment risk; willingness to save tax refunds; willingness to delay retirement; willingness to reduce retirement spending; willingness to save more now by spending less now; and willingness to downsize in retirement.

30. The non-transitory computer-readable medium bearing code according to claim 25 wherein the one or more financial goals are selected from the group consisting of: home purchase; estate planning; retirement; insurance; a major purchase; and education.

31. The non-transitory computer-readable medium bearing code according to claim 25 wherein the set of financial strategies comprise one or more selected from the group consisting of: increasing savings; increasing investing; delaying retirement age; delaying pension withdrawal age; optimizing withdrawal plans; and optimizing investment strategies.

32. The non-transitory computer-readable medium bearing code according to claim 25 wherein the set of financial strategies comprises one or more selected from the group consisting of: saving retirement surpluses to an individual retirement account; adjusting government benefit or pension start date; adjusting retirement expenses; downsizing to a rental property and investing the capital; downsizing to a less expensive home and investing the capital; working part time during retirement; saving even more for retirement; adjusting retirement age; adjusting old age benefits start date; withdrawing proportionally from all account types; limiting taxable withdrawals; manage taxable income level; withdrawing proportionally while preserving individual retirement account; saving to individual retirement account during retirement; redeeming low-tax investments first; and using an individual retirement account with tax advantages.

33. The non-transitory computer-readable medium bearing code according to claim 25 wherein the third subset of the stream of inputs comprises answers to one or more questions selected from the group consisting of: age of the client; number of dependents and ages thereof; physical location of the client; current salary; and projected retirement age.

34. The non-transitory computer-readable medium bearing code according to claim 25 wherein the method further comprises repeating steps (c) to (1) for a second financial goal.

35. The non-transitory computer-readable medium bearing code according to claim 25 wherein after step (1), the artificial intelligence tests the financial plan against one or more stresses and displays contingency strategies.

36. The non-transitory computer-readable medium bearing code according to claim 25 wherein during step (g), a respective one of the set of financial strategies is accessed more than once for determining optimum timing of a decision.

37. A method for developing a financial plan for achieving one or more financial goals, said method comprising:
a) issuing, over a network, a stream of questions to a user computing device;
b) receiving, over the network, a stream of inputs from a user for a financial plan module in response to the stream of questions, at least a first subset of the stream of inputs defining one or more financial goals, a second subset of the stream of inputs defining client lifestyle preferences and a third subset of the stream of inputs defining client financial information;
c) executing the financial plan module to generate a first financial plan comprising the one or more financial goals using the stream of inputs;
d) displaying the first financial plan to the user;
e) running an artificial intelligence engine, said artificial intelligence engine:
f) analyzing the stream of inputs and determining client lifestyle parameters from the client lifestyle preferences;
g) accessing each respective one of a set of financial strategies and executing the financial plan module to generate a respective one of a set of modified financial plans, each respective one of the set of modified financial plans representing the first financial goal as modified by the respective one of the series of financial strategies;
h) assigning a score to each respective one of the set of modified financial plans based on an increase in said respective one of the set of modified financial plans relative to the first financial plan and a cost of the corresponding respective one of the series of financial strategies based on client lifestyle parameters; and
i) ranking each respective one of the set of modified financial plans relative to each other based on said respective score; and
j) selecting a highest ranked modified financial plan of the set of modified financial plans; and
k) modifying the display to show the highest ranked modified financial plan,
l) at the user computer device, said user accepting or rejecting the highest ranked financial plan, wherein:
if the user rejects the highest ranked financial plan, modifying the display to show the next highest ranked financial plan;
if the user accepts the highest ranked financial plan, asking the user if the financial goal has been met, wherein:
if the first financial goal has not been met, setting the accepted highest ranked financial plan as the first financial plan and repeating steps (e) to (l) until the financial goal has been met.

38. The method according to claim 37 wherein the display is modified in real time.

39. The method according to claim 37 wherein the artificial intelligence further modifies the display to show the respective one financial strategy corresponding to the highest ranked modified financial plan.

40. The method according to claim 37 wherein steps (e) to (l) are repeated for a second financial goal.

41. The method according to claim 37 wherein the second subset of the stream of inputs comprises answers to one or more questions selected from the group consisting of: projected retirement lifestyle; tolerance for investment risk; willingness to save tax refunds; willingness to delay retirement; willingness to reduce retirement spending; willingness to save more now by spending less now; and willingness to downsize in retirement.

42. The method according to claim 37 wherein the one or more financial goals are selected from the group consisting of: home purchase; estate planning; retirement; insurance; a major purchase; and education.

43. The method according to claim 37 wherein the set of financial strategies comprises one or more selected from the group consisting of: increasing savings; increasing investing; delaying retirement age; delaying pension withdrawal age; optimizing withdrawal plans; and optimizing investment strategies.

44. The method according to claim 37 wherein the set of financial strategies comprises one or more selected from the group consisting of: saving retirement surpluses to an individual retirement account; adjusting government benefit or pension start date; adjusting retirement expenses; downsizing to a rental property and investing the capital; downsizing to a less expensive home and investing the capital; working part time during retirement; saving even more for retirement; adjusting retirement age; withdrawing proportionally from all account types; limiting taxable withdrawals; manage taxable income level; withdrawing proportionally while preserving individual retirement account; saving to individual retirement account during retirement; redeeming low-tax investments first; and using an individual retirement account that provides tax advantages.

45. The method according to claim 37 wherein the third subset of the stream of inputs comprises answers to one or more questions selected from the group consisting of: age of the client; number of dependents and ages thereof; physical location of the client; current salary; and projected retirement age.

46. The method according to claim 37 wherein after step (l), the artificial intelligence tests the financial plan against one or more stresses and displays contingency strategies.

47. The method according to claim 37 wherein after step (l), the artificial intelligence engine reviews the financial plan for opportunities for respective ones of the set of financial strategies that provide a benefit to the financial plan without a cost according to the client lifestyle parameters.

48. The method according to claim 37 wherein during step (g), a respective one of the set of financial strategies is accessed more than once for determining optimum timing of a decision.

49. A method for training an artificial intelligence to develop a financial plan for achieving one or more financial goals, said method comprising:
a) issuing, over a network, a stream of questions to a user computing device;
b) receiving, over the network, a stream of inputs for a financial plan module in response to the stream of questions, at least a first subset of the stream of inputs defining one or more financial goals, a second subset of the stream of inputs defining client lifestyle preferences and a third subset of the stream of inputs defining client financial information;
c) executing the financial plan module to generate a first financial plan comprising the one or more financial goals using the stream of inputs;
d) displaying the first financial plan to the user;
e) running an artificial intelligence engine, said artificial intelligence engine:
f) analyzing the stream of inputs and determining client lifestyle parameters from the client lifestyle preferences;
g) accessing each respective one of a series of financial strategies and executing the financial plan module to generate a respective one of a set of modified financial plans, each respective one of the set of modified financial plans representing the first financial goal as modified by the respective one of the series of financial strategies;
h) assigning a score to each respective one of the set of modified financial plans based on an increase in said respective one of the set of modified financial plans relative to the first financial plan and a cost of the corresponding respective one of the series of financial strategies based on client lifestyle parameters; and
i) ranking each respective one of the set of modified financial plans relative to each other based on said respective score; and
j) selecting a highest ranked modified financial plan of the set of modified financial plans; and
k) modifying the display to show the highest ranked modified financial plan,
l) at the user computer device, said user accepting or rejecting the highest ranked financial plan, wherein:
if the user rejects the highest ranked financial plan, modifying the display to show the next highest ranked financial plan;
if the user accepts the highest ranked financial plan, asking the user if the financial goal has been met, wherein:
if the first financial goal has not been met, setting the accepted highest ranked financial plan as the first financial plan and repeating steps (e) to (l) until the financial goal has been met,
characterized in that said artificial intelligence engine is configured to learn knowledge about general financial plan preferences from past ones of client financial plans and apply the learned knowledge to future ones of client financial plans.

50. The method according to claim 49 wherein the artificial intelligence engine is configured to analyze past ones of client financial plans for commonalities between the client financial information, the client lifestyle preferences and the highest ranked financial strategies.

51. The method according to claim 49 wherein the artificial intelligence engine is configured to analyze past ones of the client financial plans for commonalities between the client financial information and the client lifestyle preferences.

52. The method according to claim 49 wherein the artificial intelligence engine is configured to analyze past ones of the client financial plans for respective ones of the financial strategies that result most frequently in the highest ranked financial plan.

53. The method according to claim 49 wherein the artificial intelligence engine is configured to analyze past ones of the client financial plans for respective ones of the financial strategies that result most frequently in the highest ranked financial plan for past client lifestyle parameters similar to the client lifestyle parameters.
